(19) United States
(12) Patent Application Publication
(10) Pub. No.: US 2010/0251986 A1
(43) Pub. Date: Oct. 7, 2010

(54) Heterocentric distributive oscillating transmission mechanism and toroidal hermetic rotary engine as its application

(76) Inventor: Panagiotis Zaraphonitis, Sparti (GR)

Correspondence Address: ZARAPHONITIS PANAGIOTIS, 66 OTHONOS-AMALIAS STR., SPARTI LAKONIAS, SPARTI, GR-231 00, GR

(21) Appl. No.: 12/661,333

(22) Filed: Mar. 26, 2010

(30) Foreign Application Priority Data
Sep. 28, 2007 (GR) 20070100594

(51) Int. Cl. F01C 1/077; F16H 35/02; F01C 9/00; H02K 33/00; H02K 35/00

(52) U.S. Cl. 123/18 A; 475/16; 418/58; 310/38

(57) ABSTRACT

Heterocentric Distributive Oscillating Transmission mechanism, as a combination of interlaced planetary systems which interconnect a drive shaft (5) and a plurality of elements (1, 2, 3), where each element, being a carrier, bears a planetary shaft (11, 12, 13) on which two planets (11r & 11a, 12r & 12a, 13r & 13a) are fixed and cooperate simultaneously and continuously with a sun (6), fixed either on the mechanism frame (4r, 4a) or on a base (9) rotatable with respect to this frame, and a sun (7), fixed on the drive shaft, some of the used toothings being of variable transmission ratio and called “odonto-knodaces” and possibly also having stepwise deployment, achieving in any case unlimited progressiveness and precision.

Toroidal Hermetic Rotary Engine, as a machine of volume variation, purely rotary and hermetically piston-bearing, consisting of toroidal pistons (1, 2, 3) being interconnected via the aforementioned mechanism, and a hollow toroidal shell (4r, 4a), which has units equally spaced along its periphery with ports to transfer mass and/or energy, each unit being called “stathmos” (station), where the aforementioned pistons, moving within this shell, perform differentiated travels per each period and form between them consecutively the volumes required by any cycle, thermodynamic, hydrodynamic, refrigerating, or a combination of these, normal or optimized, a kinematic process, called “meta-stathmeusis” (re-stationing) being added to this cycle, via which a cycle completed at a “stathmos” is forwarded to the next “stathmos”, while, since each piston has both faces active and the number of pistons is equal to the number of periods of the thus extended cycle, the period performed at one face of a piston is afterwards performed at its other face, so that each period is always performed between two pistons and all periods are performed consecutively between any two pistons, this operation being called “diadocho-kinesis” (successive motion).

An application of this machine and of the mechanism incorporated in it is the internal combustion engine, with a clearly smoother and more efficient operation, especially a version with five strokes rearranged in three periods, with the travel of the expansion phase being an unlimited multiple of the travel of the intake phase, while other applications are electric generators and electric motors, hydraulic pumps and hydraulic motors, pneumatic pumps and pneumatic motors, refrigeration machines and Stirling engines, the last being of exceptional interest.

### TECHNICAL TERMS

Planetary Mechanism, Mechanism Frame, Rotatable Reaction Base, Element, Carrier, Drive Shaft, Sun, Planetary Shaft, Planet, Gear, “Odonto-Knodax” (Cam Gear), “Overlap Avoidance Helical Configuration”,

Machine of “Volume Variation”, Machine of “Chemical Volume Variation” (Internal Combustion Engine), Machine of “Mechanical Volume Variation”, Machine of “Thermal Volume Variation”, Toroidal Shell, Toroidal Piston, Piston Face, Piston Peripheral Rib, Piston Arm, Piston Hub, Pair of Cooperating Pistons, Peripheral Slot of Toroidal Shell, “Stathmos” (Station), Intake/Inlet Port, Exhaust/Outlet Port, “Thermopylae” (Heat “Ports”), Exhaust Gas Collector, Electric Engine, Electric Generator, Electric Motor, Hybrid Engine.

Main Axis, Planetary Axis, Generating Line of Toroid, Angular Dimension, Angular Position, Angular Distance, Angular Travel, Axial Direction, Axial Position, Axial Thickness,

Transmission Ratio, Variable Transmission Ratio, Toothing Formation Point, Pressure Angle, “Helical Toothing Gradient”, Progressiveness,

“Period”, “Meta-Stathmeusis” (Re-Stationing) Process, “Diadocho-Kinesis” Operation, Functional Cycle, Thermodynamic Cycle, Hydrodynamic Cycle, Refrigeration Cycle, “Extended Kinematic Cycle”, “Cycle Propagation Direction”, Compression Ratio,

Procedures Redistribution, Periods Rearrangement, Motion Distribution.

(The terms in quotation marks are newly introduced and suggested as the most appropriate for each case in order to define newly introduced Structures and Processes.)

### TECHNICAL FIELD

The invention relates to a mechanism which kinematically interconnects a plurality of elements which rotate around a common central axis, this mechanism thus forming the central core about which may be structured any machine which involves the coaxial rotation of its elements at variable and different for each element velocities, the main applications of this mechanism in the large family of such machines being in:

Machines of volume variation in general, wherein a variation of a certain volume is effected exclusively via the motion of an element generally termed piston, this motion, therefore, being called piston stroke, but often also displacement or sweep, said machines being referred to in the international documentation also as volumetric machines or positive displacement machines, said machines being:
Machines of chemical volume variation which perform a thermodynamic cycle, the chemical energy of an appropriate air-fuel mixture being directly converted, via combustion, to mechanical work during said cycle, said machines being hereafter referred to as internal combustion engines under the substantial agreement that this term will be restricted solely to the particular category of internal combustion engines which are related to the aforementioned notion of piston stroke.
Machines of mechanical volume variation which either use mechanical work as an input and produce fluid pressure, either hydraulic or pneumatic, at their output, hence being called either hydraulic pumps or pneumatic pumps, respectively, or vice versa, hence being called either hydraulic motors or pneumatic motors, respectively, under the substantial agreement that these machines are also in this case related to the aforementioned notion of piston stroke.
Machines of thermal volume variation which either use thermal energy derived from external combustion or other heat sources, like the sun, as an input and produce mechanical work at their output, hence being called Stirling engines, or vice versa, i.e. they consume mechanical work at their inlet and perform a refrigeration cycle, hence being called either refrigeration machines or heat pumps, under the substantial agreement that these machines are also in this case related to the aforementioned notion of piston stroke.

Electric machines with a multiple-part rotor, of improved efficiency or other particular specifications, using either single-phase current or multi-phase current, for conversion either of mechanical work to electric energy, being electric generators, or electric energy to mechanical work, being electric motors.

Hybrid engines which are a combination of the aforementioned electric engines either with machines of volume variation, in general, or with machines of chemical volume variation, in particular, said hybrid engines having cooperating sections which manage different forms of energy, directly and most efficiently.

### RELEVANT PRIOR ART

In order to retrieve other mechanisms currently in use, of any degree of relation to the mechanism of the present invention, one may refer to the international documentation and to simple or specialized applications and implementations related, of course, to the aforementioned categories of machines, whereby pretty soon it is made clear that the machines of volume variation of any kind have at times become the object of significant research efforts, aiming either at the improvement of these mechanisms or at their complete replacement with innovative and more efficient mechanisms, therefore everything that forms part of the state of the art can be located through the exhaustive review of the most important machines of volume variation alone.

The aforementioned machines of volume variation are indeed widely used and especially the internal combustion engines constitute the vast majority of mobile energy production units of any kind, both for terrestrial and for marine use, while they are also used in stationary energy production units or in mobile energy production units for aerial use, where reaction engines of any kind undoubtedly prevail.

Further on we will focus on internal combustion engines in particular, since any conclusions reached will also be relevant to and apply to the other categories of machines of volume variation, the latter being clearly simpler than internal combustion engines, both in construction and in operation.

While there have been numerous, important and quite distinct efforts to produce internal combustion engines even since the era when steam engines prevailed, efforts which are distinguished by their broad vision and intelligence, their revolutionary and creative spirit, their persistence and patience, up to this day only two types of such engines have finally prevailed, namely the reciprocating piston engines and the Wankel-type rotary engines.

On one hand, reciprocating piston engines are distinguished for their incomparable reliability, precisely because they use the already established technology of sealing the piston within the cylinder via sealing rings inside grooves and have thus been able to fulfill for a long time the ever increasing ecological but also economical requirements of low fuel consumption and low pollution exhaust gases, but they face problems of kinematic nature, which consist mainly in undesirable oscillations or even barely tolerable vibrations, because the kinematic solution chosen, this being none other than the combination of a crank with piston rods, allows neither the smooth operation nor the flexibility of applying kinematic improvements on the thermodynamic cycle itself.

On the other hand, Wankel engines are impressive due to their naturally self-evident design, from a kinematic point of view, and, indeed, as far as their implementation is concerned, they appear to have a markedly smooth, almost rotary motion, but they face serious sealing problems and, as a result, they have an uncertain future due to the aforementioned ecological, but also economical trends, or some extremely complex supplementary arrangements need to be applied, before the main engine in order to improve the combustion and after the main engine in order to refine the exhaust gases, said arrangements completely distorting the whole philosophy of simplicity and efficiency marking the initial idea behind this engine.

Apart from the two very important and well-established engine categories just mentioned, more specific efforts to configure an even more efficient, both piston-bearing and rotary, internal combustion engine have been made, leading to engines which met no further development and application, some of these engines resembling a particular application of the mechanism of the present invention merely as to the fact that they also have a toroidal shell and toroidal pistons, said engines appearing in documents with the publication numbers:

GB367234 (Applicant: J. Dedieu—Publication: 1932),

U.S. Pat. No. 3,670,705 (Applicant: S. Masahiro—Publication: 1972),

U.S. Pat. No. 3,990,405 (Applicants: J. Kecit et al—Publication: 1976),

US20040261757 (Applicants: A. Nathan et al—Publication: 2004),

US20050263129 (Applicant: M. Wright—Publication: 2005),

WO/1986/006786 (Applicants: H. Groeneveld, H. Soltess—Publication: 1986),

WO/2001/081729 (Applicant: L. Fragiacomo—Publication: 2001),

WO/2006/042423 (Applicant: VGT Technologies Inc.—Publication: 2006),

but being substantially different from the specific application of the Mechanism of the present invention, mainly because they suffer in the following domains:
sealing, since they have a peripheral slot in their toroidal shell requiring one peripheral sealing element as a basis and an additional peripheral sealing element for each group of pistons, which means that in the case of three groups of pistons four peripheral sealing elements are required, whereas in the present invention only two peripheral sealing elements are required, for any number of separate groups of pistons,
kinematic flexibility, because they have a limited number, usually just two, of piston groups with differentiated motions and are thus capable of performing only the most basic of the motions required by a thermodynamic cycle, and, most importantly,
kinematic interconnection of their moving parts, because they use either a crank and piston rods in various versions, or cams and followers in various versions, or gears in various configurations, with a very poor progressiveness, or other elements and methods, such as push rods and plungers of temporary connection or immobilization, with a very poor, kinematically, operation, which may develop even into a prohibitively knocking behaviour.

Apart, also, from the aforementioned inventions, the inventions with the following publication numbers also refer to the configuration of a pure mechanism similar to the mechanism of the present invention:

EP0371690 (Applicant: K. Takimoto—Publication: 1990),

WO/2004/053356 (Applicant: F. Muller—Publication: 2004),

being, however, also substantially different from the mechanism per se of the present invention.

Finally, the invention with the publication number:

WO/2007/125373 (Applicant: P. Zaraphonitis—Publication: 2007),

which hereafter will be referred to as “Concentric Distributive Oscillating Transmission” is similar to the mechanism of the present invention, but also differs substantially from it, since the power distribution or collection in the former is achieved via a common, for all the elements, planet, being called a poly-planet, said configuration leading to a severe topological complexity, while in the present invention the power distribution or collection is achieved via a common, for all the elements, sun, said configuration leading to a small number of additional moving parts, but also to a clearly superior, topologically, structure with incomparable compactness and robustness.

### TECHNICAL PROBLEM TO BE SOLVED

From the point of view of the main application of the mechanism of the present invention, that means from the point of view of the machines of volume variation and especially of internal combustion engines, the challenge that the technical world is faced with nowadays, as long as it is seriously intended that thermal engines of any kind remain dynamically in the foreground, is to design from scratch an engine capable, on the one hand, of combining as many virtues as possible, and, on the other hand, of avoiding as many drawbacks as possible from the ones found in the aforementioned categories of engines.

Experience up to now has shown that the design of such an engine should be done literally on a completely new basis. It is proven absolutely necessary to apply the sealing technology of piston engines, but it is strongly questioned whether the quest for an optimal way of power transmission, from its point of production via combustion to the engine output, has been set on a proper basis.

Taking into account all that has been mentioned above, the exceptional kinematic simplicity of the Wankel-type rotary engines appears to set the absolute standards, but is, unfortunately, absolutely bound to the particular function of this engine and cannot be isolated and applied to other types of engines, therefore, the systematic application of hybridization principles cannot bear fruit in this case and it is absolutely necessary that any available technique for the development of innovative ideas be used, the sole guidelines being the application of optimal sealing and the simplicity of power transmission after its production, the final aim being definitely a piston-bearing but also most probably a rotary engine, far superior to all engines currently in use.

Since, however, an intensive research activity worldwide has already started decades ago and is still ongoing, with the objective of designing such an engine, and since the proven, via other achievements, most competent independent researchers and the proven, via other successful applications, most efficient scientific and technological institutes, take part in this struggle, with overwhelming technical, design, computational and manufacturing means, yet no satisfactory result has been produced, the following question plausibly arises:

is it technically possible to design and, even further, to manufacture such an engine?

### DISCLOSURE OF THE INVENTION

A specific application of the present invention gives a definitely affirmative answer to the previous question, said application constituting the simplest, and at the same time the most effective, proposal with regard to the aforementioned challenge:

The Toroidal Hermetic Rotary Extended Expansion Engine (THREEE), built around the Coplanar Heterocentric Interactive Distributive Oscillating Transmission (CHIDOT), is an engine which combines in the best possible manner the advantages of the reciprocating piston engine with those of the rotary engine, being both piston-bearing and purely rotary, while avoiding the crucial problems that these two types of engines have.

In general, this engine consists of a shell which is an almost continuous hollow toroid, either stationary or moving in space, and of pistons which are parts of either a solid or a hollow toroid, of appropriate dimensions so as to cooperate with the shell, each of said pistons having two active faces, said pistons moving within the shell with respect both to the shell and to each other, performing a purely rotary motion, so that the internal surface of the shell, on the one hand, and the faces of two successive pistons lying opposite each other, on the other hand, form, consecutively and at the proper position, the volume required at each period of a thermodynamic cycle, the complex sequence of these motions being effected via a special planetary mechanism which connects the pistons to the engine drive shaft kinematically and either receives torque from the pistons or transmits torque to the pistons.

For a most clear presentation of the structure and operation of the engine and in order to explain some of its peculiarities, it is necessary at this point to proceed to the following agreements, on condition that the engine drive shaft moves in one direction:
each piston has a “front face” and a “rear face”, the meaning of these terms being obvious with regard to the direction of motion of the pistons, said terms having a permanent character,
we consider the processes taking place in the space between two, any, successive pistons, said pistons being called a “pair of cooperating pistons”, wherein a “leading piston” and a “following piston” are distinguished, the meaning of these terms being obvious with regard to the direction of motion of the pistons, said distinction being only temporary and valid so long as reference is made to the specific pair of cooperating pistons.

The internal surface of the shell, in particular, is a toroidal surface, i.e. a surface of revolution, the generating line of this surface being any planar, closed and smooth curve lying completely on one side of and at an adequate, for manufacturing and operational purposes, distance from the revolution axis of construction of the toroidal surface, said axis coinciding with the functional central axis of the engine being called “main axis”, the most appropriate generating line being the ellipse and the simplest curve suggested being the circle, while the external surface of the shell may be of any form, satisfying any manufacturing requirements.

The continuity of this hollow toroid is interrupted only by a peripheral slot which extends on the whole periphery of the shell at any angular position on the generating line of the toroidal surface and preferably on its inner side, i.e. the side lying towards the revolution axis of construction of the toroidal surface, and having an axial width determined by mechanical strength requirements, since said peripheral slot is required for the mechanical connection of each piston to a central, different for each piston, hub via an arm.

In addition, the shell has units of an appropriate number, equally spaced along its periphery, each of said units being called a “stathmos” (station) and having at least one “intake” port, at least one device for effecting “ignition” by any means (via spark or via fuel injection at a self-ignition pressure or otherwise) and at least one “exhaust” port, and possibly also other openings and devices (preheating, cooling and others) for improving the performance of a thermodynamic cycle.

The pistons in particular, are almost identical in structure, while each piston is formed on a structural frame made of a material of high strength and low density and designed in such a manner that the necessary strength for receiving any force and torque produced during the performance of the thermodynamic cycle is achieved, together with the least possible moment of inertia and centrifugal force.

A connecting rod is used with its two ends fixed on the two toroidal parts of the piston close to the two active faces, no other connection between said rod and the structural frame of the piston being present, the thermal expansion coefficient of said rod being less than or equal to the thermal expansion coefficients of the other structural parts that constitute the structural frame of the piston, so that the deviation from the toroidal shape caused by the temperature changes is dimensionally compensated for, said toroidal shape being maintained, at least in the regions close to the faces, and consequently the required excellent cooperation between said faces and the respective internal surface of the shell is pursued.

Each piston has two limiting faces, which are the surfaces generated by the section of certain parts of a toroid, i.e. a solid of revolution, the external limit of the cross-section of said solid being derived from the internal limit of the cross-section of the shell via an internal offset by a radial gap, necessary for the differentiated expansions, due to different materials or different temperatures during the operation of the engine, while the revolution axes of construction of the pistons and the functional axis of rotation of the pistons coincide with the main axis, resulting in that a most hermetic sealing of the pistons with respect to the cooperating internal shell walls is achieved, via the sealing rings inside grooves lying on the body of the toroids, in a meridian plane, close to both faces.

Moreover, the piston faces have any appropriate shape which favors the most effective production of torque with respect to the rotation axis of the pistons, by the pressure generated by the exhaust gases, said piston faces fitting each other perfectly when the complete expulsion of exhaust gases at each thermodynamic cycle is required, wherein the simplest such shape to be used is the plane and particularly the meridian plane.

Furthermore, each piston has a peripheral rib, i.e. a peripheral extension, said extension being practically part of the ring of the toroidal shell which was cut out in order to form the peripheral slot, said peripheral rib having an axial thickness corresponding to the one of the cut out ring and being deployed from an angular position between the piston faces, which lies at an adequate, with regard to mechanical strength, angular distance from the, either rear or front, piston face, towards this face, extending outside the piston body boundaries towards the, either following or leading, respectively, piston, said peripheral rib having an angular width such as, on the one hand, to cover adequately the opening of the peripheral slot when the, either following or leading, respectively, piston is at its maximum distance from said piston, and, on the other hand, to allow for the unobstructed relative motion of the two pistons up to the point where their cooperating faces contact each other.

Inside grooves formed on the peripheral rib of the piston and on the opposite, with regard to the axial direction, sides of the peripheral slot of the shell, there are two groups of peripheral sealing elements, one of said groups being held inside a groove on the aforementioned peripheral rib, and thus following the motion of the piston, the other being held inside a groove on the peripheral slot of the shell, and thus covering continuously the whole periphery and following the motion of the shell, each of said groups consisting of at least two elements situated on both sides of the peripheral rib with regard to the axial direction, said sealing elements either having a special meander cross-section or being spring steel elements or elements of special chemical composition or a combination of these, thus ensuring the hermetic sealing of the pistons with the cooperating shell walls in the peripheral direction.

Each piston also has lateral surfaces, which are the convex surfaces of conjugate to the shell toroids, at angular positions on the generating line of the toroid where their presence is necessary for sealing the intake port and the exhaust port.

Finally, each piston has an arm fixed on said peripheral rib on the whole of its axial thickness and extending to an adequate, with regard to mechanical strength, angular width, from the edge of the peripheral rib located between the piston faces to the, either rear or front, depending on the deployment of the peripheral rib, face position, thus supporting the main body of the piston and also supporting the peripheral rib on the whole of its angular width, said arm extending, right after its fixing on the peripheral rib, in parallel to the machine central axis and in both directions to an adequate height with regard to the capacity of receiving any non-axial torque, said arm extending from these two edges in two planes perpendicular to the main axis, up to the area around this axis, where two hubs, respectively, having their centers on said axis, are formed and receive any non-axial torque, allowing only the unobstructed rotation of the piston, and since all pistons are supported on a central shaft, said pistons always having rotational freedom, it follows that the hubs are formed at axially different planes and, therefore, although preferably identical in shape, differ in their axial support position, while the hubs of each piston preferably have the same axial distance.

Besides, the pistons are functionally absolutely identical and have appropriate angular dimensions, are of an appropriate number and are distributed along the periphery of the shell in such a manner, that for each pair of cooperating pistons, the rear face of the leading piston and the front face of the following piston form, consecutively and at the appropriate position, the volumes required at each period of the thermodynamic cycle, while all periods are performed simultaneously.

The “intake” ports, any other required openings and the “exhaust” ports of each “stathmos” (station) are alternately covered by lateral sealing and uncovered, depending on the relevant requirements, solely via the motion of the pistons within the shell, without there being need for the presence of other elements, resulting in the reduction of the number of moving parts to a minimum.

Since the position where the ignition takes place, if it is required, is specific and fixed on the shell, an electric circuit is activated on each “stathmos” (station), solely via the motion of the pistons as well, without there being need for the presence of other elements, such as the classic electric distributor in other engines, resulting also in the reduction of the number of moving parts to a minimum.

This engine, due to its internal kinematic mechanism, is capable of performing any thermodynamic cycle, executing all the required motions with the greatest efficiency possible, and especially it is capable of performing extremely specialized motions of an optimized, even an ideal, thermodynamic cycle, such as:
differentiated angular travels per each period of the thermodynamic cycle, so that the rear face of the leading piston and the front face of the following piston are, consecutively, in surface contact at the beginning of the “intake” phase, aiming at the intake solely of air-fuel mixture, at some, predetermined by the intended compression ratio, angular distance at the end of the “compression” phase, at another predetermined angular distance at the end of the “expansion” phase, which is a practically unlimited multiple of the angular distance of the “intake” phase, dependent on the requirement of complete or optimal exploitation of the exhaust gas energy, and in surface contact again at the end of the “exhaust” phase, aiming at the complete expulsion of the produced exhaust gases,
an additional kinematic process, which is called “meta-stathmeusis” (re-stationing) and via which the purely thermodynamic cycle is repeated again at the next “stathmos” (station), and as the “stathmoi” (stations) are located at equal intervals, the complete process, which is called an “extended kinematic cycle”, i.e. the purely thermodynamic cycle and the “meta-stathmeusis” (re-stationing) process, may be repeated ad infinitum and it is also possible to impose the incorporation of a parting of the cooperating pistons in the “meta-stathmeusis” (re-stationing) process, at an opening on the shell which lies between the exhaust port of one “stathmos” (station) and the intake port of the next “stathmos” (station), resulting in the most effective cooling and/or cleaning, even via brushes, of the working faces, but also allowing maintenance work, such as the replacement of a spark plug, if said spark plug is located on a piston, without there being need for engine dismantling, which is potentially unsafe and certainly time consuming and costly, while the “meta-stathmeusis” (re-stationing) process may either constitute on its own one or more periods or be incorporated in the already existing periods, and it is proven extremely useful as it allows for a considerable time interval between the thermodynamically active periods, so that the stressed materials have a sort of rest and are relieved of critical thermal stresses, and the metallic, ceramic and other natural and synthetic materials are structurally restored and this facilitates cooling, even via air, but also allows for heavier stress on these materials, at higher levels of torque production or higher operating speed.

Then, all the piston motions are designed on the basis of an ideal thermodynamic cycle, taking into account all the contact forces and inertial forces, so that both the acceleration and the deceleration of each piston are performed optimally, while it is possible to achieve the oscillating intake of the air-fuel mixture for improved mixing, and its in-motion combustion for an improved combustion, since the placement of the spark plug or of the injection nozzle either on the leading piston or on the following piston or on both pistons and the resulting differentiation of the flame propagation rate inside a compressed air-fuel mixture, said mixture also being subject to the favorable effect of inertial forces, is only a matter of choice.

Parallel to the aforementioned motions of the pistons, due to the fact that each piston has two active faces and consequently participates in two successive pairs of cooperating pistons, the other pairs of cooperating pistons also perform consecutively the same motions with the appropriate phase difference, while the whole process, which may be repeated ad infinitum, is called “diadocho-kinesis” (successive motion) operation.

Besides, precisely because of the fact that each piston has two active faces, it follows that the period that is performed between the rear face of the leading piston and the front face of the following piston, may afterwards be performed at the space either before the front face of the leading piston or behind the rear face of the following piston, an option which thus also defines the direction of propagation of the cycle, said direction being either the same as or opposite to the direction of motion of the pistons, respectively, always viewed within an extended kinematic cycle.

The performance of all the required motions, with precision and progressiveness (the latter in the sense of keeping the maximum value of the derivative function of the output travel with respect to the input travel relatively low), but also with an absolutely constant engagement, and without any auxiliary mechanisms for accelerating, decelerating or immobilizing the pistons, is achieved via a special combination of planetary systems, said combination being called “Heterocentric Interactive Distributive Oscillating Transmission” mechanism.

The structural parts of said mechanism are:
a frame, stationary or moving in space,
one shaft per piston, rotating around an axis which lies in parallel and eccentrically with respect to the central axis and being called “planetary axis”, said shaft being thereby called “planetary shaft”, said shaft being supported with only rotational freedom on a socket configuration formed on both branches of the arms of each piston, said socket configuration receiving any torque of non-axial direction exerted on the planetary shaft, while on both branches of the arms openings are formed, which allow the unobstructed relative angular motion of the planetary shafts of other pistons with respect to said piston,
one planet per piston, which is possibly a machine element of special type, fixed on said planetary shaft and therefore rotating around the planetary axis, this machine element being called an “action planet”,
one planet per piston, which is also possibly a machine element of special type, fixed on said planetary shaft at an axial position different from the one of the action planet and therefore also rotating around the planetary axis, this machine element being called a “reaction planet”,
either one sun per action planet at a different axial position per each action planet, or one sun common for all the action planets, which is possibly a machine element of special type, rotates around the main axis in a direction which is either the same as or opposite to the one of the rotation of the pistons, when viewed within a complete kinematic cycle, and cooperates either exclusively with the specific action planet with which it is designed to cooperate or with all the action planets simultaneously, respectively, either distributing or collecting power, depending on the direction of the transmitted torque, this machine element being called an “action sun”,
either one sun per reaction planet at a different axial position per each reaction planet, or one sun common for all the reaction planets, which is possibly also a machine element of special type, fixed either on the frame of the mechanism or on a base which is able to rotate around the main axis, with respect to the frame of the mechanism, and can be used to achieve the adjustment of the travels and/or the timing of the mechanism during its operation, by imparting rotation to said base, either absolutely independently or in synchronization with the other motions, finite or perpetual, the axis of said sun coinciding with the main axis, said sun cooperating either exclusively with the specific reaction planet with which it is designed to cooperate or with all the reaction planets simultaneously, respectively, this machine element being called a “reaction sun”.

The term “Heterocentric” Transmission relates to the aforementioned configuration, according to which the required planets achieve the desired kinematic interconnection of the pistons between them, while they are located at different angular positions around the central axis and therefore their planetic axes of rotation define different centers on a plane perpendicular to said central axis, as opposed to the configuration of the Concentric Distributive Oscillating Transmission, where the likewise defined centers of all the required planets coincide.

The operation of said mechanism is as follows:

The planetary shaft of each piston, due to the simultaneous cooperation of the reaction planet with the conventionally stationary reaction sun and of the action planet with the action sun, the latter being actually the (input or output) drive shaft of the mechanism, and due to the rotation of said action sun, is forced simultaneously to rotate around its planetary axis and to revolve around the central axis of the machine, said motions being both of variable velocity, while the carrier on which said planetary shaft is supported, i.e. the arm of the respective piston, is also forced to rotate around the central axis, because of the revolution of the planetary shaft around the central axis.

Due to the fact that the planetary shaft of any piston, as just described above, appears during the design, initially, with two degrees of freedom, one of which, i.e. the possibility of revolution around the main axis, is afterwards constrained via the prescribed motion of the specific piston, the arbitrary definition of the rotation of this planetary shaft around its planetary axis takes place as well, so that the condition that the mean value of the variable transmission ratio, both between the reaction sun and the reaction planet and between the action sun and the action planet, is a rational number, is in any case satisfied, which means that at an integral number of complete revolutions of the action and the reaction sun corresponds an integral number of complete revolutions of the action and the reaction, respectively, planet, this condition ensuring that, after appropriate integral numbers of complete revolutions of all the cooperating elements, these elements will return again at their initial position of engagement.

However, in the case where it is required that the action sun and the action planet are standard gears, the planetary shaft performs an oscillating motion both around the main axis and around its planetary axis, therefore it is not possible for the reaction sun and the reaction planet to be standard gears as well.

Likewise, in the case where it is required that the reaction sun and the reaction planet are standard gears, the planetary shaft performs an oscillating motion both around the main axis and around its planetary axis, therefore it is not possible for the action sun and the action planet to be standard gears as well.

Finally, when the arbitrarily defined motion of the planetary shaft around its planetary axis is any other than the ones just described above, it is not possible neither for the action sun and the action planet nor for the reaction sun and the reaction planet to be standard gears.

Hence, in the case where any two machine elements cooperate in a pure rotation, and it is required that the motion of at least one of them is oscillating, the toothing must be of a special construction and more precisely of a variable transmission ratio, and consequently, reference is not made to cooperating standard gear wheels but to an application of a combination of their design philosophy with the design philosophy of cams, cams being machine elements capable of producing an oscillating motion, whereby each of these special machine elements may be called “odonto-knodax” (cam gear).

According to the above discussion, the motion of the planetary shaft around its planetary axis is arbitrarily defined, satisfying mainly the condition of progressiveness, i.e. of keeping at a minimum, and in any case within allowable limits, the fluctuation of the variation of the transmission ratio, so that the value of the pressure angle is kept within the limits found also in standard toothings, this result allowing for further improvement by controlling and adjusting the rest of the design parameters of the toothing per se.

Thus, given the relative motion between the action sun and the action planet, the ratio of transmission between them, whether constant or variable, is calculated and the respective toothing profile is constructed.

Likewise, given the relative motion between the reaction sun and the reaction planet, the ratio of transmission between them, whether constant or variable, is calculated and the respective toothing profile is constructed as well.

In the case that, during the operation of a pair of either standard gears or “odonto-knodaces” (cam gears), the mean value of the transmission ratio is not a rational number, i.e. an integral number of revolutions of one does not correspond to an integral number of revolutions of the other, and it is required that one of the two machine elements, whether standard or of special type, rotates by more than one complete revolution, then, if the toothings are planar, a part of one toothing will meet with a part of the other toothing with which it is not meant to cooperate, this having certainly disastrous consequences, this case being termed a “Non-conjugate Toothing Overlap”.

In the case, also, that the mean value of the transmission ratio is a rational number, said condition taking place in the majority of standard gear applications and also being satisfied in the present application, which is most important for the present analysis, the aforementioned problem is solved within the plane by juxtaposing the same toothing profile repeatedly, the number of repetitions being derived from the reduced fraction of the aforementioned mean value of the transmission ratio, but although this solution gives very good results with standard gears, except in extreme cases where said reduced fraction is a ratio of very large integers, the same proposal for “odonto-knodaces” (cam gears), in the vast majority of cases, leads to a great restriction of the angular space within which the variation of the transmission ratio has to be effected, resulting finally in that this variation becomes extremely abrupt and in that the derived pressure angle is non-functional and impossible to manufacture, this case being termed a “Variation Space Shrinkage”.

In order to face the aforementioned undesirable circumstances, in special cases of standard gears but also, mainly, in the majority of cases of “odonto-knodaces” (cam gears) with significant fluctuation of the variable transmission ratio, the toothings of cooperating elements, where it is required that at least one element rotates by more than one complete revolution, are deployed at different axial positions, either discontinuously, in a stepped mode for different parts of the toothing, i.e. stepwise, or continuously, i.e. helically, the deployment in both cases being called, as a generalized case, an “Overlap Avoidance Helical Configuration”, the thus generalized “helix” having an appropriate generalized “gradient” (with the meaning of the ratio of the produced axial displacement to the respective angular displacement) so that, on the one hand each of said elements cooperates exclusively with the element with which it is designed to cooperate, and, on the other hand, the axial height of said helical configuration, and consequently the total axial height of the mechanism, are not excessively increased.

Remark:

The overlap avoidance helical configuration defined above is in no way related to the currently used helical toothing per se or, more precisely, it is an application of the same, but rather inversed, rules of its construction under a more macroscopic view, meaning that, as in the case of the currently used helical toothing, an additional turning angle is imposed for each contact point on a tooth, dependent on the axial position and aiming at an overlap of operating periods of successive teeth, respectively in the case of overlap avoidance helical configuration an axial displacement for each tooth is imposed, either once per tooth or in an absolutely continuous manner, aiming, on the contrary, at the avoidance of an overlap of non-conjugate operating periods, and if, for reasons of strength and operation of the toothings or for smoother and more quiet operation of the machine, the use of the currently known helical toothing is also required, there is no problem in the coexistence of these two different types of spatial deployment.

All the toothings are fixed with the required mechanical strength directly on the respective shafts, and said toothings may be either all external or a combination of external toothings for all the planets and internal toothings for all the suns, the latter arrangement being advantageous from a topological aspect, but not efficient for considerable and abrupt fluctuations of the transmission ratio.

During the aforementioned “helical” deployment process, the only requirement is that each formation point of the toothing of one element corresponds both angularly and axially to the respective formation point of the cooperating toothing of the other element, the “helical” deployments being either of opposite directions for the two cooperating elements in case of using external toothings for all the elements or of the same direction in a different case.

Furthermore, from the aforementioned “helical” deployment process, result conjugate toothings that are consequently completed after an integral number of turns (with the meaning of the material deployment), in general different for each toothing, said toothings having additionally at least half a tooth before their starting point, the profile of said tooth corresponding to the one right before the ending point, and at least half a tooth after their ending point, the profile of said tooth corresponding to the one right after the starting point, said additions being in accordance with the aforementioned “helical” deployment.

Due to the aforementioned additions, the engagement of each element with the corresponding cooperating element is absolutely constant and when the cooperation of the “helical” toothings is terminated at one of their two ends, a new cooperation has already started at their other end, with the degree of overlap of the toothings, during the transition of their engagement from the ending point to the starting point anew, being exactly the same as the degree of overlap of the toothings between teeth, and it is in fact possible to improve the degree of overlap further, in order to achieve an even smoother and more quiet operation, by applying the currently used helical toothing, and in any case without any mechanism of immobilization or temporary connection.

For those toothings which are required to be deployed “helically”, it is recommended, although not absolutely necessary, that the “helices” are continuous for all the elements, and of constant pitch for all the suns, mainly for reasons of mechanical strength, especially in case that the sun is common for all the planets and therefore exposed to greater stresses.

Finally, it is recommended that all the used toothings, either planar or “helically” deployed, for all the elements of the same type, i.e. for all the action suns, when these are more than one, and for all the reaction suns, when these are more than one as well, and for all the action planets and for all the reaction planets as well, are identical.

In the case of one separate action sun per action planet the cooperation between them is simple and already described, but in the case of a common action sun for all the action planets, at each period the respective to said period section of the toothing of the action sun will cooperate with the respective section of the toothing of the action planet of any one piston and afterwards the next section of the always unitary toothing of the action sun will cooperate with the next section of the toothing of the action planet of the same piston performing uninterruptedly the next period, while the initial, for the present description, section of the toothing of the action sun will be at a proper position to cooperate with the respective section of the toothing of the action planet of the next piston so that the latter piston will perform the respective period, and so on ad infinitum, the action sun being in continuous engagement with all the action planets simultaneously.

Likewise, in the case of one separate reaction sun per reaction planet the cooperation between them is simple and already described, but in the case of a common reaction sun for all the reaction planets, at each period the respective to said period section of the toothing of the reaction planet of any one piston will cooperate with the respective section of the toothing of the reaction sun and afterwards the next section of the toothing of the reaction planet of the same piston will cooperate with the next section of the always unitary toothing of the reaction sun performing uninterruptedly the next period, while the initial, for the present description, section of the toothing of the reaction planet of the next piston will be at a proper position to cooperate with the respective section of the toothing of the conventionally stationary reaction sun, so that the latter piston will perform the respective period, and so on ad infinitum, the reaction sun being in continuous engagement with all the reaction planets simultaneously.

From another point of view, it is possible to locate the socket configuration of the planetary shaft at the side opposite to the side of the main body of the piston, with respect to the central axis, so that said socket configuration and the corresponding planetary shaft can act as a counterweight to the main body of the piston, without there being need for the presence of any other element for the static and dynamic balancing of the mechanism.

As shown by the detailed presentation of this combination of planetary systems, when the design and the implementation of its distributive structure and operation are practicable, a significant saving of machine elements and especially of those with toothings of variable ratio, and also an important degree of compactness and robustness are achieved.

In the more simplified version of the engine, the shell is stationary in space and the engine output, i.e. the shaft which produces work and is therefore called a “drive shaft”, is the action sun, while the introduction of air-fuel mixture and the gas exhaust are achieved by stationary piping fixed on the shell.

In the more advanced version of the engine, the action sun is stationary in space or fixed on a rotatable base, with the same properties as the rotatable base of the reaction sun previously described, and the drive shaft is the shell, while the introduction of air-fuel mixture is effected from the external space on the moving shell via piping and rotary type sealing and the gas exhaust is effected via a specially configured stationary exhaust gas collector, among the advantages of this arrangement being the even smoother engine operation, but also the drawing off of any residual exhaust gas energy via their aerodynamic reaction on the appropriately curved walls of the exhaust gas collector, said reaction leading to an additional torque on the moving shell.

Remarks:

At this point it should be stressed that the extended kinematic cycle has been divided into periods so that at each period the action sun performs the same angular travel, while the number of these periods is equal to the number of the pistons, so that, at any given moment, each period is performed exclusively on one piston and on each piston is performed exclusively one period, and afterwards the same period is performed on the next piston and on the same piston is performed the next period, so that on each piston are performed sequentially all periods and each period is performed sequentially on all pistons, a matter on which no explicit reference had been made before, since a number of crucial questions had to be examined thoroughly prior to this designation, such as “which are all the required processes for the optimal execution of any functional cycle?”, or “how is it possible for all these processes to constitute a unified and unobstructedly repeated operation?”, and, finally, “in which way is it possible to redistribute said processes so that a number of periods results, which allows for the optimal design and manufacture of such an engine?”.

Furthermore, it should be stressed that the term “Period” is used instead of the term “Stroke”, on the one hand because it represents a substantially different meaning, for the reason that after the aforementioned redistribution of processes it is possible for a Period to include a part of a Stroke or, more frequently, more than one complete Strokes, where the term “Stroke” has its current meaning in technical terminology of a “Time Interval in a Process”, and on the other hand because the term “Period” already exists in the english technical terminology with exactly the same meaning as in the present proposal, while at the same time the confusion by the use of the term “Stroke”, which sometimes has the meaning “Period of Time” and sometimes the meaning “Displacement in Space”, is avoided.

After all these explanations it is rendered clear enough that in order to define the Periods, there is a technique which consists in a redistribution of all required processes, as already described, in a total rearrangement and distribution of all these in a specific and optimum number of Periods, and in a precise kinematic design of all these Periods except one, because, due to the mathematical properties of the “Diadocho-Kinesis” Operation, the remaining Period is defined by the other already defined Periods.

### APPLICATION EXAMPLE

Following the way of the presentation until now, for a most proper explanation of the structure and operation of the mechanism, it is deemed necessary to present a specific application of this mechanism, wherein it appears as the interconnecting internal mechanism of an internal combustion engine, while it is advisable to show firstly the kinematic and dynamic requirements that arise from the operation of this engine and afterwards the manner in which these requirements are satisfied by the proper design of the particular parts of this mechanism and especially of the toothings of variable transmission ratio.

This internal combustion engine, in particular, is an engine with petrol as its fuel, i.e. a gas engine, either with a carburetor or with direct or indirect fuel injection, the extended kinematic cycle in said application consisting of three periods, which are:

| | |
|---|---|
| First Period: | Intake - Compression, |
| Second Period: | Expansion, |
| Third Period: | Exhaust - Meta-Stathmeusis (Re-Stationing). |

We assign to the number of periods of the extended kinematic cycle an equal number of pistons. We also select the following manufacturing parameters:

Static Parameters:

Number of “stathmoi” (stations): one,

Generating line of internal toroidal surface: circle,

Piston face: meridian plane,

Peripheral slot position: internally,

Peripheral rib direction: to the following piston,

Peripheral rib support: fully supported on the whole of its angular width by the arm of the piston,

Type of ignition unit: spark plug,

Position of ignition unit: center of rear face of the piston,

Type of toothings for reaction sun and reaction planet: external and of variable transmission ratio, i.e. external “odonto-knodaces” (cam gears),

Topology and type of cooperation of reaction sun: planar and common for all the reaction planets,

Type of toothings for action sun and action planet: external and of constant transmission ratio, i.e. external standard gears,

Topology and type of cooperation of action sun: planar and common for all the action planets.

Since all used suns and planets are planar, the exerted forces, both on the action and on the reaction side, are applied exclusively within one plane, different for each side, which allows for the term “Mechanism of Coplanar Application of Forces” or, briefly, “Coplanar Mechanism”.

Kinematic Parameters:

Drive shaft: action sun,

Toroidal shell: stationary with respect to the frame of mechanism,

Frame of mechanism: stationary in space,

Reaction sun: fixed on a rotatable, with respect to the frame of the mechanism, base,

Direction of propagation of functional cycle: opposite to the direction of rotation of the pistons,

Direction of rotation of action sun: opposite to the direction of rotation of the pistons,

Number of revolutions of action sun per cycle: half,

Number of revolutions of planetary shaft around its planetary axis per cycle: one,

Angular travel of Intake phase per cycle to periphery ratio: one to five,

Angular travel of Expansion phase per cycle to periphery ratio: three to five.

In this specific application the ratio of the angular travel of Expansion phase to the angular travel of Intake phase is three to one, which explains the use of the term “Extended Expansion” Engine, while it is possible for this ratio to be as large as desirable, in the sense that the maximum travel of Expansion phase that this engine can achieve is firstly defined and afterwards, taking into account the respective ratio suggested by the Theory of Combustion, the travel of Intake phase is calculated.

Due to these selections, a balanced arrangement is achieved between the ratio of the air-fuel mixture intake volume per drive shaft revolution to the total torus volume and the ratio of the exhaust gas expansion volume per drive shaft revolution to the total torus volume on the one hand, and the minimum root width at the most highly loaded point of the “odonto-knodaces” (cam gears), the pressure angle value and, therefore, the toothing efficiency on the other hand.

The engine which corresponds to the aforementioned manufacturing parameters is shown in the attached figures:

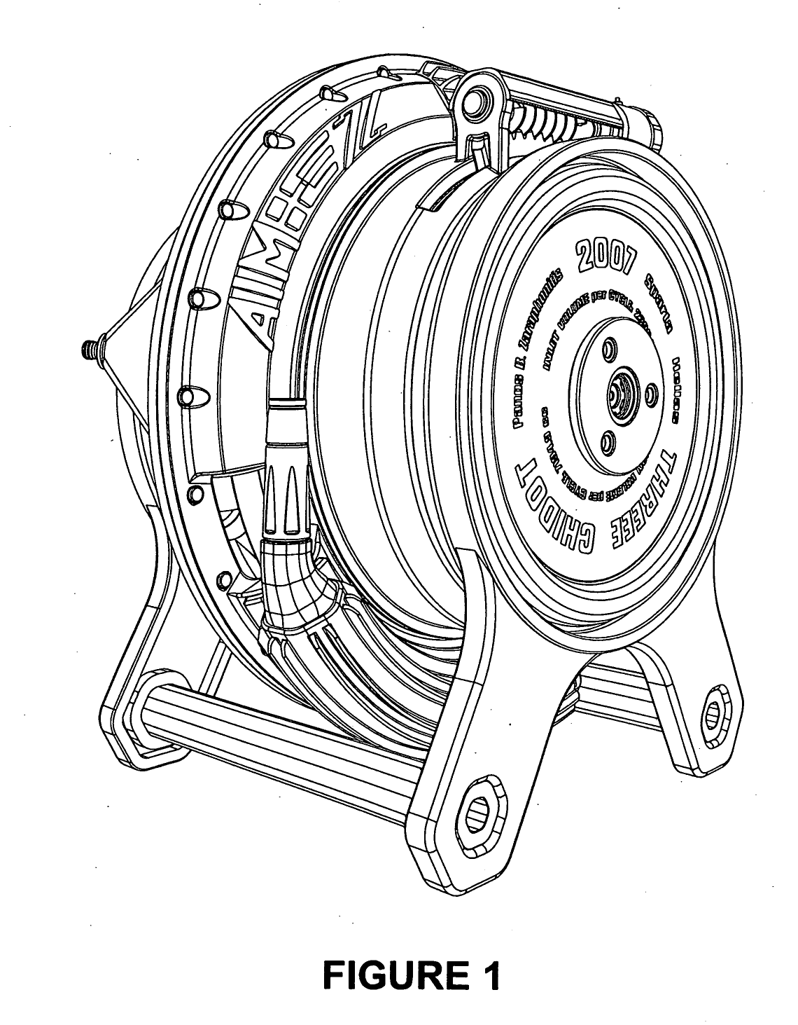

In FIG. 1 the engine is shown in a perspective inclined, front-to-side, view, whereas all other figures show axonometric views.

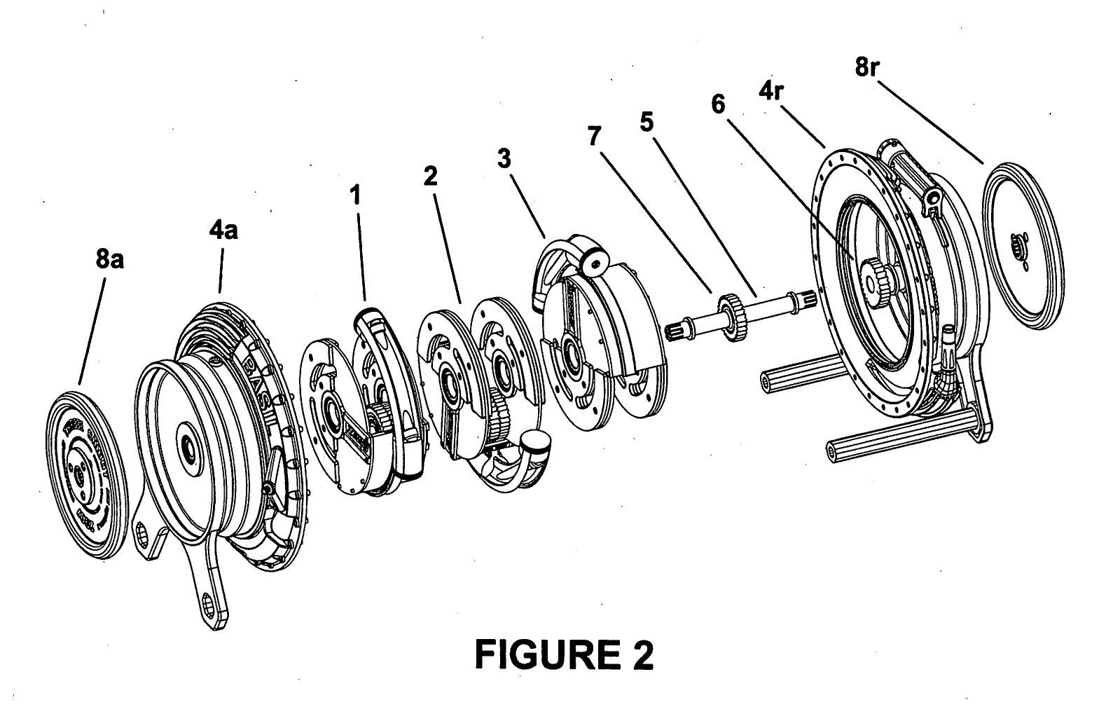

In FIG. 2 the engine is shown in an inclined, front-to-side, exploded view, whereby the stationary and moving parts it consists of are shown in more detail.

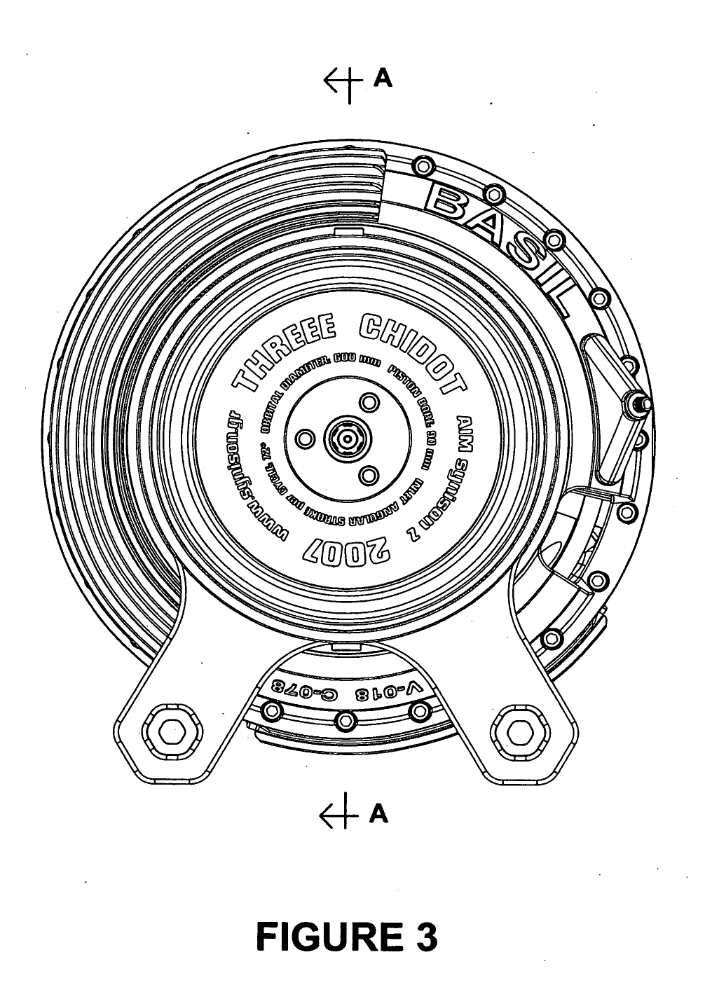

In FIG. 3 the engine is shown in a side view, showing also the dividing lines for the cross-section A-A that follows.

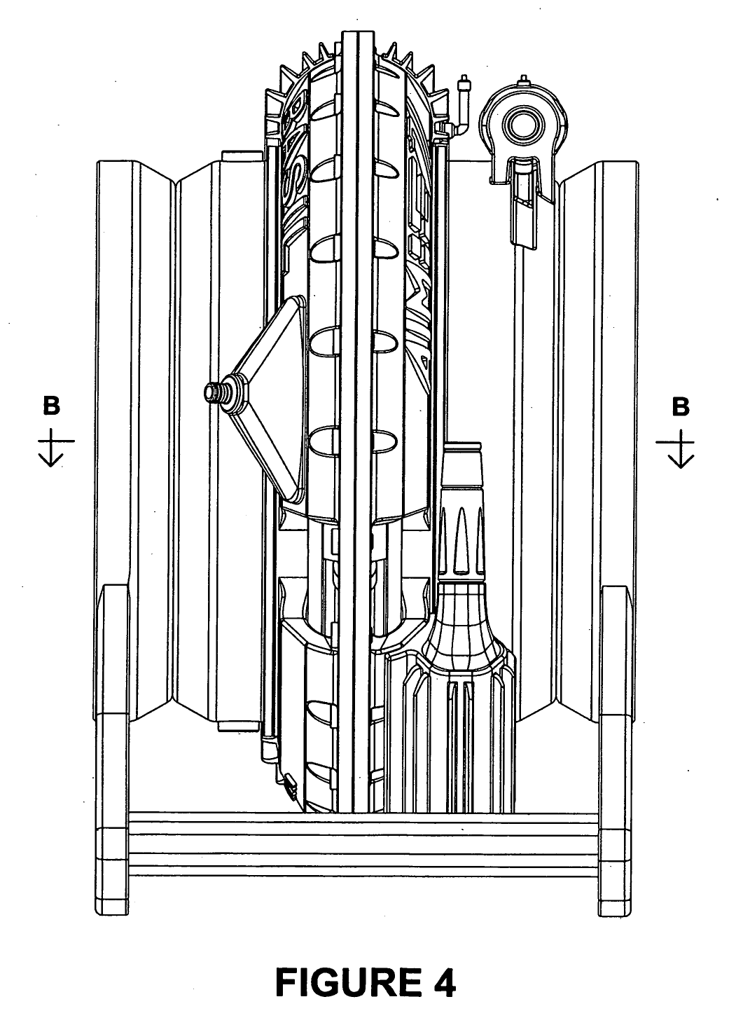

In FIG. 4 the engine is shown in a front view, showing also the dividing lines for the cross-section B-B that follows.

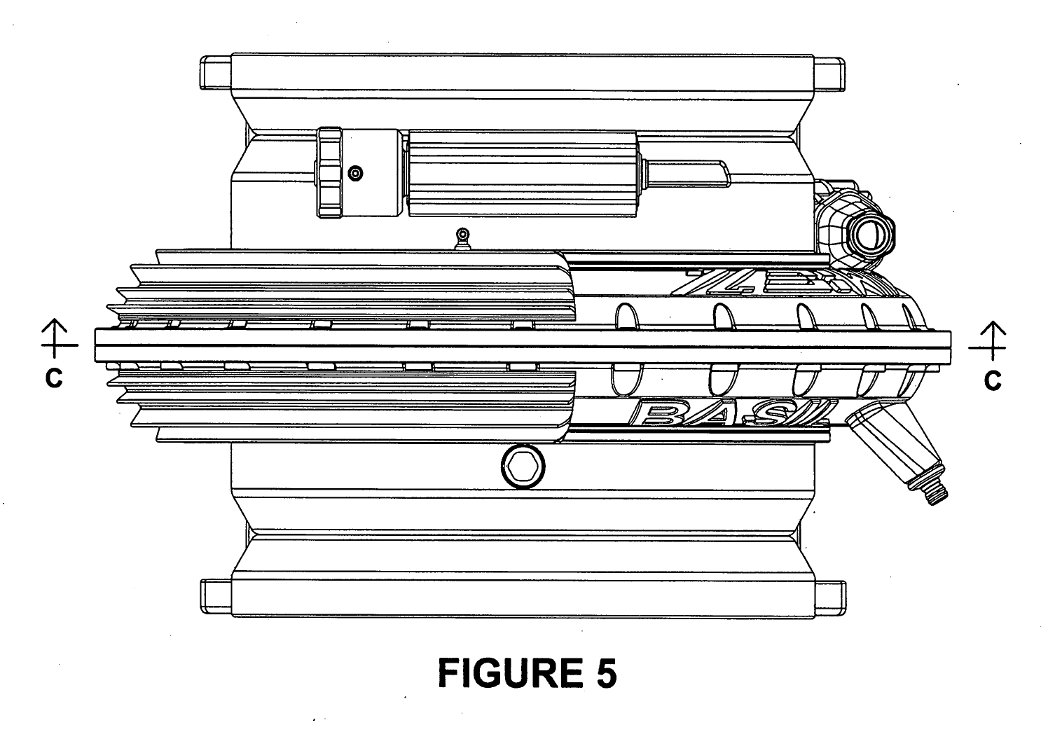

In FIG. 5 the engine is shown in a plan view, showing also the dividing lines for the cross-section C-C that follows.

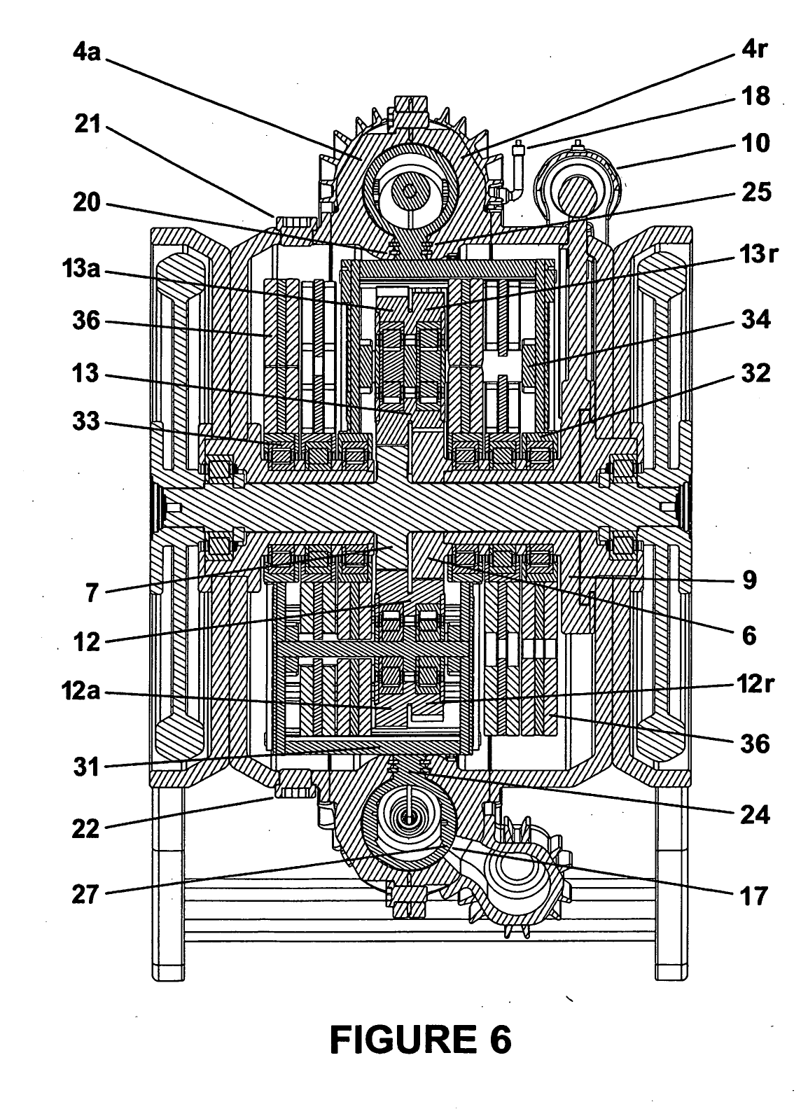

In FIG. 6 an engine cross-section along line A-A of FIG. 3 is shown, said cross-section being of capital importance for understanding the structure of the engine.

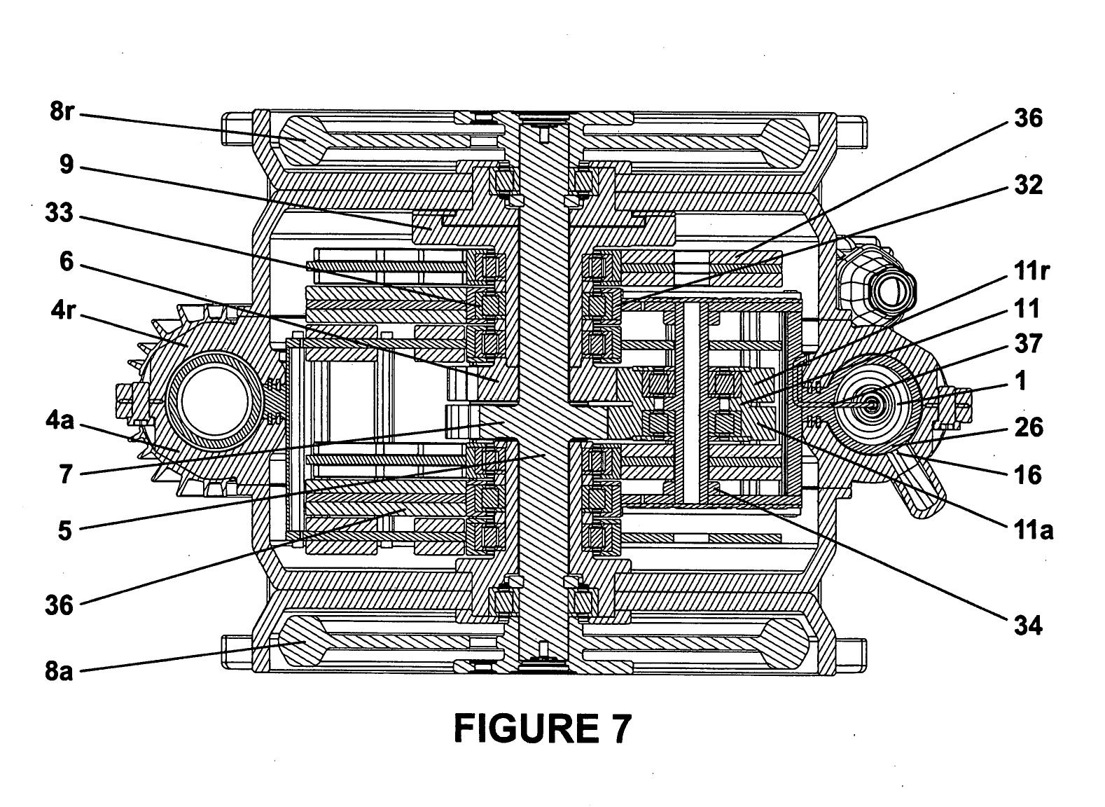

In FIG. 7 an engine cross-section along line B-B of FIG. 4 is shown, whose section plane is, of course, the meridian plane of the whole engine and at the same time the meridian plane of the planetary shaft of piston number 1, resulting in the complete disclosure of the structure of both the group of parts fixed together to form the body being called, as a total, piston, and the system of levers and the power flow therethrough, starting from the action sun, continuing to the unitary body made up of the action planet, the planetary shaft and the reaction planet and ending at the reaction sun and its rotatable base and consequently at the stationary in space frame of the engine, and vice versa, while the forces produced on both active faces of the piston, as well as all the inertial forces involved, are exerted simultaneously on the planetary shaft.

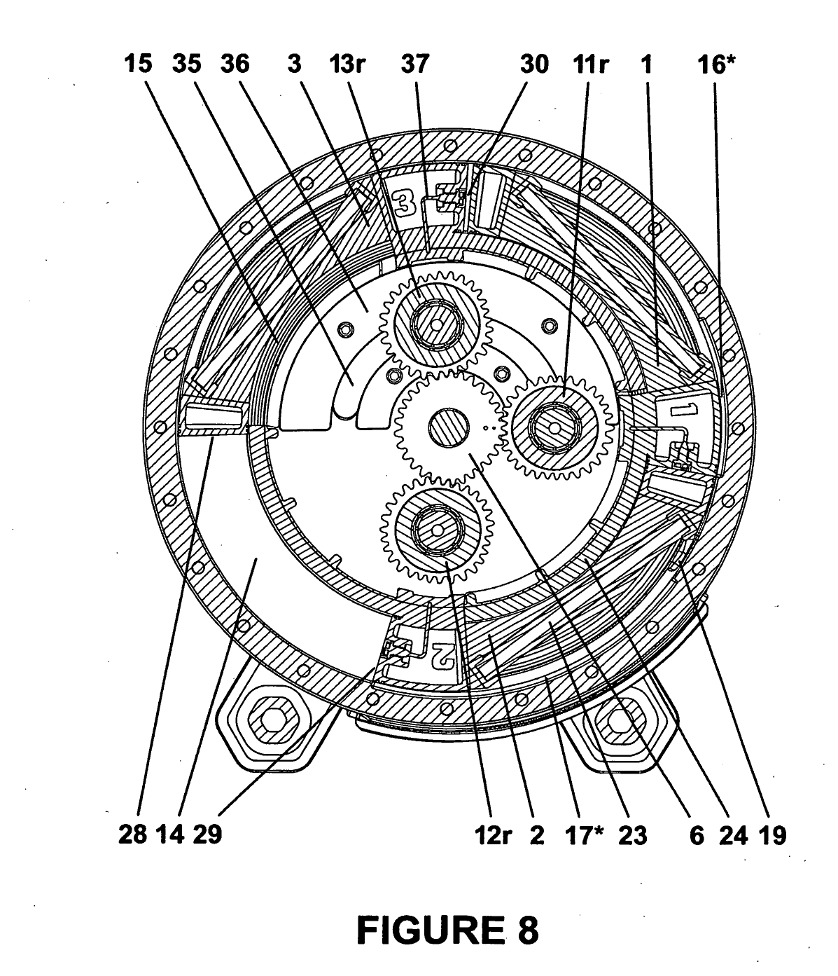

In FIG. 8 an engine cross-section along line C-C of FIG. 5 is shown, said cross-section being also very important for understanding the structure of the engine, but also by far the most appropriate for understanding the operation of the engine.

The numbers appearing in FIG. 2, FIG. 6, FIG. 7 and FIG. 8 represent the following:

Bodies, in general:

1—piston number 1, as a total,

2—piston number 2, as a total,

3—piston number 3, as a total,

4r—first half of stationary toroidal shell, to the reaction side, with mounting legs and connecting rods,

4a—second half of stationary toroidal shell, to the action side, with mounting legs,

5—drive shaft, with splined formation for power transmission on both ends,

6—reaction sun, fixed on a rotatable, with respect to the shell, base,

7—action sun, fixed on the drive shaft,

8r—flywheel, on the reaction side, with screwed flange formation for power transmission,

8a—flywheel, on the action side, with screwed flange formation for power transmission,

9—rotatable base of reaction sun, for adjusting travels and/or timing of the engine,

10—actuator of reaction sun rotatable base, for adjusting travels and/or timing of the engine,

11—planetary shaft of piston number 1, with reaction planet and action planet fixed on it,

11r—reaction planet, fixed on planetary shaft of piston number 1,

11a—action planet, fixed on planetary shaft of piston number 1,

12—planetary shaft of piston number 2, with reaction planet and action planet fixed on it,

12r—reaction planet, fixed on planetary shaft of piston number 2,

12a—action planet, fixed on planetary shaft of piston number 2,

13—planetary shaft of piston number 3, with reaction planet and action planet fixed on it,

13r—reaction planet, fixed on planetary shaft of piston number 3,

13a—action planet, fixed on planetary shaft of piston number 3.

Shell, in particular:

14—internal surface of the toroidal shell,

15—peripheral slot of the toroidal shell,

16—fuel intake port,

16*—fuel intake port (shown on this cross-section only in order to explain the operation of the engine),

17—gas exhaust port,

17*—gas exhaust port (shown on this cross-section only in order to explain the operation of the engine),

18—external permanent electric supply, for the spark plug,

19—gap between exhaust port and intake port, for cooling/cleaning and inspection/maintenance,

20—peripheral sealing ring, fixed on the toroidal shell,

21—cap for filling oil sump of the engine,

22—cap for emptying oil sump of the engine.

Piston (any piston), in particular:

23—thermally compensating connecting rod of structural frame of the piston,

24—peripheral rib, for sealing of the peripheral slot of the shell, with meander shape,

25—peripheral sealing ring, fixed on the peripheral rib of the piston,

26—lateral sealing surface of fuel intake port, on the piston,

27—lateral sealing surface of gas exhaust port, on the piston,

28—front face of the piston,

29—rear face of the piston,

30—spark plug, on the piston,

31—arm supporting the body and the whole peripheral rib of the piston,

32—hub supporting the piston, with rotary freedom,

33—roller-bearing of the hub supporting the piston,

34—socket configuration, supporting the planetary shaft, on the arm of the piston,

35—opening on the arm of the piston, for the unobstructed motion of other planetary shafts,

36—piston static and dynamic balancing counterweight, having the shape of a circular sector,

37—electric circuit, from the brush cooperating with the shell rail to the spark plug.

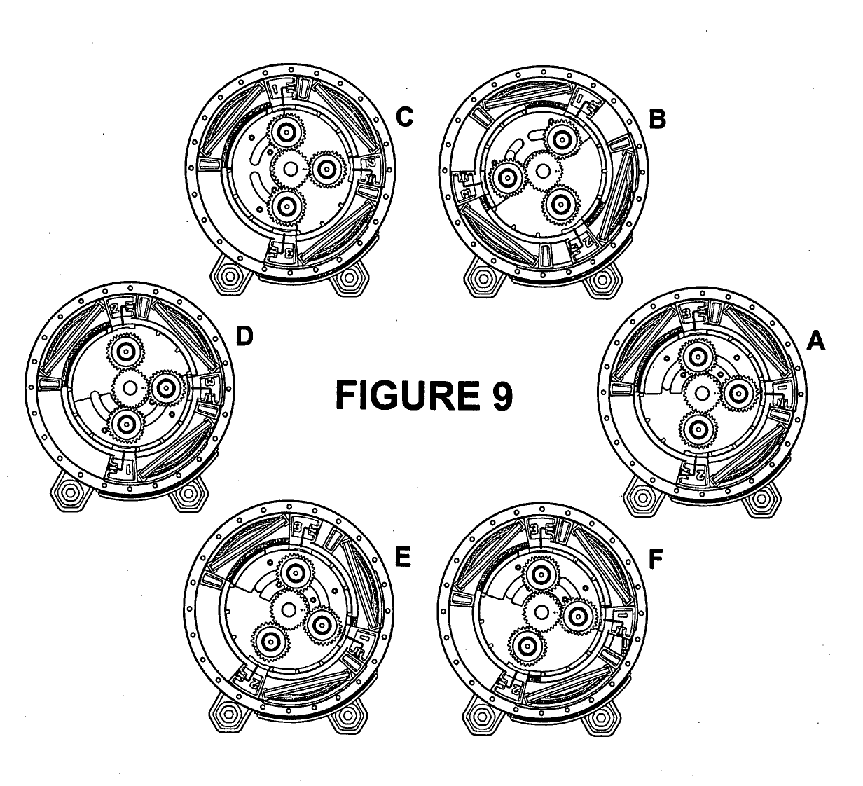

In FIG. 9 the same cross-section C-C of the engine as in FIG. 8 is shown, at specific successive phases of its functional cycle, for an exhaustive presentation of the operation of the engine.

It should be noted here that the fuel intake port and the gas exhaust port are arranged at different angular positions on the generating line of the toroid, therefore the fuel intake port, which appears correctly only in cross-section B-B of FIG. 7 and the gas exhaust port, which appears correctly only in cross-section A-A of FIG. 6, also appear in cross-section C-C of FIG. 8, only for the purpose of explaining the operation of the engine.

It should be noted, also, that the socket configuration of the planetary shaft, in this specific presentation, is not located at the side opposite to the side of the main body of the piston, with respect to the central axis, hence said socket configuration and the corresponding planetary shaft do not act as a counterweight to the main body of the piston for the static and dynamic balancing of the mechanism, this arrangement having been chosen only for the purpose of better explaining the operation of the engine, since it is much clearer which planetary system corresponds to each piston.

From another point of view, it should be noted that in reality, for assembling reasons, some elements are constructed separately and are fixed together during their assembly, forming a larger group which is called a “moving part”, therefore, for the purpose of explaining, all these elements have a common hatch, while the same rule applies to the rotatable base of the reaction sun, for the reason that in this specific presentation the angular position of said rotatable base and of the reaction sun has been regulated and is fixed with respect to the frame of the engine.

Likewise, for the purpose of explaining and contrary to the conventional rules of Drawing, the hatches used for the drive shaft, which is in fact the only pure shaft in the whole of this mechanical assembly, and for the cylindrical rollers of the bearings, respectively, are the same as the hatches of all the other elements of the group that makes up their moving part.

Finally, the drawings of the six discrete main phases of the operation of the engine have been arranged on the same page, forming an easily understandable cyclic diagram, for the purpose of explaining the alternation of these phases at a glance, and therefore the inclusion of the corresponding hatches has been avoided in order to have clear, not blurred drawings.

In order to examine a complete operating cycle of the mechanism and the whole engine thoroughly, and taking into account the aforementioned figures, we consider that the engine drive shaft rotates in the conventionally forward direction in mathematics, i.e. anti-clockwise, and we assign numbers to the pistons in the conventionally opposite direction in mathematics, hence in the pair of cooperating pistons (1) and (2) the leading piston (1) and the following piston (2) are distinguished, and so on.

Therefore, the cycle, conventionally as well, starts with the leading piston (1) and the following piston (2) being in contact and at such position with respect to the shell that the rear face (29) of the piston (1) and the front face (28) of the piston (2) are located at the start of the fuel intake port (16) (FIG. 9, phase A).

From this point the leading piston (1) moves fast until its rear face (29) reaches the so-called “fore position of intake”, achieving the induction of exclusively air-fuel mixture, while the following piston (2) moves more slowly until its front face (28) reaches the end of the fuel intake port (16), thus blocking said port, said end of the fuel intake port (16) lying at an angular distance from the “fore position of intake” which is defined as the angular travel of Intake phase, hence the first phase “Intake” of the first period “Intake—Compression” has been performed (FIG. 9, phase B).

From this point the leading piston (1) moves slowly until its rear face (29) reaches the so-called “fore position of compression”, while the following piston (2) moves faster until its front face (28) reaches the so-called “rear position of compression”, said “rear position of compression” lying at an angular distance from the “fore position of compression” which is determined by the angular travel of Intake phase and the compression ratio, hence the second phase “Compression” of the first period “Intake—Compression” has been performed (FIG. 9, phase C).

From this point the following piston (2) moves very slowly, while the leading piston (1) moves slightly faster so as to clear itself of the point of locally maximum proximity of the pistons, said point constituting for said kinematic mechanism the so-called “neutral point”, which is unavoidably present in any mechanical oscillating system, and at the proper moment the ignition process is activated, resulting in that the leading piston (1) moves following an optimal kinematic and dynamic design, under the pressure exerted by the exhaust gases, until its rear face (29) reaches the beginning of the gas exhaust port (17), while the following piston (2) also moves, more slowly of course, following a different, but optimal as well, kinematic and dynamic design, said design having taken into account the inertial contribution of the violent motion of the burning mass of the air-fuel mixture to the flame propagation, until its front face (28) reaches the so-called “rear position of expansion”, keeping the combustion process almost isovolumic for the time period imposed by the theory of combustion, whereby the chemical energy of the air-fuel mixture is turned into mechanical energy on the drive shaft by the applied kinematic mechanism in the most effective possible manner, while this “rear position of expansion” lies at an angular distance from the beginning of the gas exhaust port (17) which is defined as the angular travel of Expansion phase, hence the second period “Expansion” has been performed (FIG. 9, phase D).

From this point the leading piston (1) moves slowly until its rear face (29) reaches the end of the gas exhaust port (17), while the following piston (2) moves faster until its front face (28) reaches the end of the gas exhaust port (17) as well, whereby said faces come in contact again achieving the complete expulsion of the produced exhaust gases, hence the first phase “Exhaust” of the third and last period “Exhaust—Meta-Stathmeusis” has been performed (FIG. 9, phase E).

From this point the leading piston (1) and the following piston (2) move being constantly in contact up to the point where the front face (28) of the following piston (2) achieves an adequate sealing of said gas exhaust port (17), then the velocities of said pistons change so that the rear face (29) of the leading piston (1) is separated from the front face (28) of the following piston (2), until a considerable gap is formed between them, located at an opening (19) of equivalent dimensions on the shell, adequate for the purpose of effectively cooling and/or cleaning, even via brushes, said piston faces during engine operation, or for inspection and maintenance work, such as the replacement of the spark plug, without dismantling parts of the engine, during engine switch-off (FIG. 9, phase F).

From this point the velocities of said pistons change again so that the front face (28) of the following piston (2) approaches the rear face (29) of the leading piston (1) until they come in contact again at a position where the rear face (29) of the leading piston (1) continues to achieve an adequate sealing of the fuel intake port (16), and from this point they move being constantly in contact until the rear face (29) of the leading piston (1) and the front face (28) of the following piston (2) reach the beginning of the fuel intake port (16), hence the second phase “Meta-Stathmeusis” of the third and last period “Exhaust—Meta-Stathmeusis” has been performed (FIG. 9, phase A, anew, and so on).

On the other hand, the parallel operation of the kinematic mechanism which is, practically, exclusively responsible for producing the motions just described, i.e. the operation of the Coplanar Heterocentric Interactive Distributive Oscillating Transmission, is as follows:

Due to the rotation of the action sun (7) and because of its cooperation with the action planet (11a, 12a, 13a), either active or passive, the respective planetary shaft (11 or 12 or 13) of each piston (1 or 2 or 3, respectively), on which said action planet is fixed, also because of the parallel cooperation of its reaction planet (11r, 12r, 13r, respectively) with the reaction sun (6), is forced simultaneously on the one hand to a rotation around its planetary axis and on the other hand to a revolution of this planetary axis around the central axis of the engine, these two motions being both of variable velocity, while said revolution around the central axis of the engine also drives the carrier on which said planetary shaft (11 or 12 or 13, respectively) is supported, said carrier being in this specific case the supporting arm (31) of the respective piston (1 or 2 or 3) around the central axis, as well.

As mentioned above, on the reaction side, the use of special toothing of variable transmission ratio has been selected for the reaction sun (6) and the reaction planets (11 r, 12r and 13r), hence at each period the respective to said period section of the toothing of the reaction planet (12r, for example) of any one piston (2, respectively) will cooperate with the respective section of the toothing of the reaction sun (6) and afterwards the next section of the toothing of the same reaction planet (12r) will cooperate with the next section of the always unitary toothing of the reaction sun (6), performing uninterruptedly the next period, while the initial, for the present description, section of the toothing of the reaction planet (13r, respectively, for the current example) of the next piston (3, respectively) will be at a proper position to cooperate with the respective section of the always unitary toothing of the conventionally stationary reaction sun (6), so as to perform the respective period, and so on ad infinitum, the reaction sun (6) being in constant engagement with all the reaction planets (11r, 12r and 13r) simultaneously.

Furthermore, due to the fact that it has been selected, on the one hand that the planetary shaft (11 or 12 or 13) of any piston (1 or 2 or 3, respectively) performs exactly one revolution in an extended kinematic cycle, and on the other hand that only one “stathmos” (station) is present, it follows that after the completion of an extended kinematic cycle, the reaction planet (11r or 12r or 13r) of any piston (1 or 2 or 3, respectively), will be at its exactly initial state, as far as both the angular position of its planetary axis with respect to the central axis and its own angular position with respect to its planetary axis are concerned (FIG. 9, phase A), i.e. said reaction planet will be facing exactly the initial position of the conventionally stationary reaction sun (6), so as to cooperate with it anew, and so on ad infinitum, being in absolutely constant engagement with it.

When the actuator operates and rotates the base of the reaction sun a certain angular travel, any in general, but finite in the current application, either absolutely independently or in synchronization with the other motions, on the one hand the said synchronization will continue to apply perfectly, since all the relative motions with respect to the reaction sun remain unaltered, and on the other hand there will be a spatial shift, with respect to the toroidal shell, of the events which take place therein, resulting in certain changes during the operation of the engine, as for example, the change of the point where the Intake phase ends and consequently of the amount of introduced air-fuel mixture, and/or the change of the point of ignition, with results similar to the ones of the ignition advance in the internal combustion engines currently in use, and/or the change of the point where the Exhaust phase begins and consequently of the degree of exploitation of the energy of the exhaust gases.

As far as the action side is concerned, as it has also been mentioned above, the use of standard toothing of constant transmission ratio has been selected for the action sun (7) and the action planets (11a, 12a and 13a), hence the situation is much simpler and both the action sun (7) and all the action planets (11a, 12a and 13a) are standard gears, so there is no problem, topological or other, due to the simultaneous cooperation of the action sun (7) with all the action planets (11a, 12a and 13a), and also no problem of discontinuity during the transition from the end of the extended kinematic cycle to the beginning of a new such cycle.

Finally, where the piston (1 or 2 or 3) is required to move slowly with respect to the shell (4r, 4a), that is during the first phase of the period “Intake—Compression” as well as during the period “Expansion” for the following piston (2) and during the second phase of the period “Intake—Compression” and the first phase of the period “Exhaust—Meta-Stathmeusis (Re-Stationing)” for the leading piston (1), or where the piston (1 or 2 or 3) is required to move fast with respect to the shell (4r, 4a), that is during the first phase of the period “Intake—Compression” as well as during the period “Expansion” for the leading piston (1) and during the second phase of the period “Intake—Compression” and the first phase of the period “Exhaust—Meta-Stathmeusis (Re-Stationing)” for the following piston (2), this is achieved via the appropriate design of the toothings of variable transmission ratio, and in any case without there being need for the presence of any other mechanism, either for immobilization or for temporary connection.

It is thereby proven that the Coplanar Heterocentric Interactive Distributive Oscillating Transmission has the virtues of a constant and self-contained engagement, i.e. the simplicity of operation, the precision and the progressiveness, and allows the design of the engine almost without limitations, the highest priority being in the satisfaction of the requirements of any thermodynamic cycle per se, from the roughest up to the finest of them.

One full operating cycle of the engine and consequently of the mechanism is thus completed, which cycle may be repeated in an identical manner at the same “stathmos” (station), and so on ad infinitum.

By observing the positions and the motions of the examined pair of cooperating pistons, it is possible to observe the positions and the motions of all other pairs of cooperating pistons as well, these being repeated consecutively with the relative phase difference, hence it is possible to follow and fully check the aforementioned “diadocho-kinesis” operation.

Remark:

After the detailed presentation of the structure and especially the operation of the engine, it is rendered clear that the internal combustion engine in question has more features than any other similar suggestion, so that it may claim the title of the sought connecting link between the classic piston-bearing reciprocating engines and the turbine engines, combining the advantages of these two categories of engines in the best possible manner, without incorporating their most critical drawbacks at the same time.

As shown above, the Coplanar Heterocentric Interactive Distributive Oscillating Transmission is capable of performing any kinematic cycle, performing all the required motions with precision, progressiveness and the greatest efficiency possible in both directions, that is either receiving or transmitting torque, and, consequently, it is the most appropriate kinematic mechanism for the other categories of machines of volume variation, since it can satisfy any thermodynamic or hydrodynamic requirements or a combination of those, and it is capable of performing any cycle, either thermodynamic or hydrodynamic or refrigerating, with the greatest total efficiency possible, while it is also the most appropriate kinematic mechanism for any other category of machines, where it is required that a plurality of elements rotate at variable and different for each element velocities, such as the electric machines with a multiple-part rotor, for the conversion either of mechanical work to electric energy or of electric energy to mechanical work.

Therefore, the machine of mechanical volume variation has a structure and operation similar to those previously mentioned, said machine in general consisting also of a shell, which is an almost continuous hollow toroid, either stationary or moving in space, having a peripheral slot, an “Inlet” port and an “Outlet” port, and of pistons, which are parts of either a solid or a hollow toroid, with dimensions corresponding to the ones of the shell, said pistons moving within the shell with respect both to the shell and to each other, in a purely rotary motion, said pistons being kinematically interconnected via the combination of planetary systems which make up the Heterocentric Interactive Distributive Oscillating Transmission.

Things are simpler in this particular case, both with regard to manufacture and with regard to operation, because fewer differentiated motions are required, since the total of periods may include just the “influx” period and the “efflux” period, while the “meta-stathmeusis” (re-stationing) process may already be incorporated in the aforementioned periods via an appropriate kinematic design.

Likewise, the machine of thermal volume variation also has a structure and operation similar to those previously mentioned, said machine in general consisting also of a shell, which is an almost continuous hollow toroid, either stationary or moving in space, having a peripheral slot and “ports” which are not necessarily actual openings allowing the passage of matter, but areas of intentionally reduced thermal insulation allowing the passage of heat, said heat “ports” being called “thermopylae”, said machine consisting also of pistons, which are parts of either a solid or a hollow toroid, with dimensions corresponding to the ones of the shell, said pistons moving within the shell with respect both to the shell and to each other, in a purely rotary motion, said pistons being kinematically interconnected via the combination of planetary systems which make up the Heterocentric Interactive Distributive Oscillating Transmission.

Things are also simpler in this particular case, both with regard to manufacture and with regard to operation, because fewer differentiated motions are required, since the total of periods may include just the “compression” period and the “expansion” period, while the “meta-stathmeusis” (re-stationing) process may already be incorporated in the aforementioned periods via an appropriate kinematic design.

Finally, the electric machine with a multiple-part rotor, for the conversion either of mechanical work to electric energy, or else electric generator, or of electric energy to mechanical work, or else electric motor, has also a similar operation, but a different structure from the machines previously described, said machine in general consisting of at least one stator, either stationary or moving in space, which is either a permanent magnet or an electromagnet, and of rotors, which are either permanent magnets or electromagnets, moving with respect both to the stator and to each other, in a purely rotary motion, said rotors being kinematically interconnected via the combination of planetary systems which make up the Heterocentric Interactive Distributive Oscillating Transmission.

Advantages:

The presentation of the advantages will be made also starting from the most complex applications of the Heterocentric Interactive Distributive Oscillating Transmission mechanism, i.e. the machines of chemical volume variation, continuing with the simpler applications of the machines of mechanical volume variation and the machines of thermal volume variation, and finishing with the applications of the electric machines with a multiple-part rotor.

Advantages in Comparison with Piston-Bearing Reciprocating Engines:

The complete absence both of “intake” valves and of “exhaust” valves, since the pistons themselves, through their motion, cover or reveal the respective ports, resulting in a drastic reduction of the number of required moving parts, while the fact that these ports are covered via lateral sealing is perfectly acceptable both with regard to manufacture and with regard to operation, since the existing pressures at these positions are kept at practically low levels.

The possibility of treating the sealing of the fuel intake port and the gas exhaust port differently, due to their disposition at different angular positions on the generating line of the toroid, via the use of different materials with different requirements in mechanical, thermal and chemical resistance, since the lateral sealing surfaces of the fuel intake port are never in contact with burning air-fuel mixture or with exhaust gas and the lateral sealing surfaces of the gas exhaust port are never in contact with air-fuel mixture.

The absence, as well, of any additional mechanism of electric current distribution, since, as the area where the ignition, if necessary, takes place is specific and fixed on the shell, an electric circuit is activated at the proper moment on each “stathmos” (station) or on the piston itself when the spark plug is located thereon, via the motion of the pistons alone, without there being need for the presence of other parts, this resulting in the drastic reduction of the number of required moving parts, as well.

Advantages in Comparison with Wankel-Type Rotary Engines:

The existence of a sufficient and effective surface for converting the total pressure exerted by the exhaust gases on the face of the piston into a force on the piston.

The existence of a sufficient and effective lever arm for converting the total force applied by the exhaust gases on the piston into a torque around the main axis.

The achievement of sealing of optimal quality during the formation of the required volume, especially during the “Expansion” period, when pressures and temperatures of critically high levels are noted, said quality approaching the quality of the respective piston sealing inside a cylinder via sealing rings inside conjugate grooves, being only slightly inferior, since a slight distortion of the cooperating parts takes place during the transformation from the geometrical shape of the cylinder to the one of the torus.

Advantages in Comparison with Other Piston-Bearing Rotary Engines:

The achievement of a perfectly adequate sealing of the peripheral slot of the shell, which is necessary for the mechanical connection of each piston to a central hub, via the peripheral rib of each, either leading or following, according to the deployment of the peripheral rib, piston, using only two groups of peripheral sealing elements, said sealing elements being either elements of a special meander shape or spring steel elements or elements of special chemical composition or a combination of these, said sealing elements being located on both sides of said peripheral rib, with regard to the axial direction.

The achievement of the smoothest possible operation of the engine, via a configuration where the number of pistons is equal to the number of periods of the aforementioned extended kinematic cycle, so that, at all times, the rear face of some piston performs the “Expansion” period and receives the driving pressure of the exhaust gases.

Advantages in Comparison with all Other Machines of Chemical Volume Variation:

An application of maximum simplicity in design, which leads to an unrivalled effectiveness, while, from this point of view, only the initial idea for the Wankel-type rotary engine is slightly superior to the present proposal, but the embodiment of this initial idea is rather inferior, because of the many problems arising in its application.

The possibility of burning a fuel of very low volatility, since, after each combustion process, and during the engine operation, an adequate gap is formed between the pistons, located at an opening of equivalent dimensions on the shell, the cleaning of the piston faces being effected through said gap, either via air or even via brushes.

The possibility of performing either inspection or even maintenance work, such as the replacement of the spark plug, if said spark plug is located on the piston, without there being need for a difficult, time consuming, costly and even unsafe dismantling of the engine.

Performance of any functional cycle with regard to thermodynamics and kinematics, since it is possible to differentiate the angular travels of the pistons within each period, and hence it is possible to perform any improving actions within any thermodynamic cycle, for a better combustion or a more efficient exploitation of the energy of the exhaust gases.

Performance of a specific thermodynamic cycle, during which the engine may start with the drawing-in of pure air-fuel mixture, continue with its compression up to a predetermined compression ratio, go on with the expansion of the burning air-fuel mixture, which results in an angular travel of the leading piston almost equal to the one required for the complete exploitation of the energy of the exhaust gases, said angular travel being a practically unlimited multiple of the angular travel of the intake phase, and finish with the complete expulsion of the exhaust gases, said cycle being capable of repetition in an identical manner ad infinitum.

Having achieved the complete expulsion of the exhaust gases, which is practically more difficult, it is also possible, if desired, to achieve the partial expulsion of the exhaust gases, either for the purpose of their complete recombustion or for performing any other improvement process, such as homogeneous charge compression ignition.

The possibility, with minimal limitations, of achieving either a practically isovolumic combustion according to the requirements of the Otto cycle or a practically isobaric combustion according to the requirements of the Diesel cycle, or any other intermediate state.

The possibility of totally stopping the operation of the engine and restarting it, with any desired frequency, in order to achieve the minimum fuel consumption, when the conditions allow it, said mode of operation being termed “Stop and Start” operation.

The possibility of preconditioning the air-fuel mixture by preheating before or during its introduction in the shell, since there is an ample, directly accessible and available for heating lateral surface of the shell, different from the combustion area.

The possibility, as well, of preconditioning the air-fuel mixture, by its in-motion or oscillating intake and the resulting improved mixing, via a design which takes into account the layers or the turbulences created or simply favoured by inertial forces.

The possibility of in-motion combustion of the air-fuel mixture for the improvement of said combustion, when the placement of the spark plug or of the injection nozzle either on the leading piston or on the following piston or on both pistons has been selected, since a differentiation of the flame propagation rate inside a compressed air-fuel mixture is achieved, said mixture being subject to the favourable effect of inertial forces due to its violent motion.

The possibility of cooling the combustion area via air, since there is also an ample, directly accessible and available for cooling lateral surface of the shell, other than the area of intake, but, to a great extent, also due to the “meta-stathmeusis” (re-stationing) process, and even more if the insertion of the parting motion of the pistons, for cooling and cleaning, takes place.

The achievement of a further improvement in the smoothness of the engine operation in the case where the shell is the drive shaft, since the ratio of the minimum to the maximum angular velocity of the part moving more slowly is considerably improved.

The possibility of further improvement of the total efficiency of the engine by the drawing off even of the residual energy of the exhaust gases in the case where the shell constitutes the drive shaft, the exhaust gases being led through the exhaust port, which terminates in the form of an inclined nozzle on the outer side of the shell, towards the appropriately curved walls of the exhaust gas collector, the shell thus being driven also by reaction in its direction of motion.

Advantages in Comparison with Other Machines of Mechanical and Thermal Volume Variation:

The achievement of unique simplicity in operation, with an excellent sealing and a minimal number of moving parts, while several of the aforementioned advantages relate clearly to both the machines of mechanical volume variation and the machines of thermal volume variation of the present proposal as well, in comparison with the respective machines being currently in use.

The possibility of disposing the low temperature area and the high temperature area in machines of thermal volume variation at any distance from each other required by the design of such machines, due to the insertion of the “meta-stathmeusis” (re-stationing) process, so that, on the one hand an excellent thermal insulation in the simplest manner is achieved, and on the other hand the refrigeration cycle per se may be optimized, resulting in the feasibility of the design and manufacture of a most efficient machine of thermal volume variation in general, and particularly of a Stirling machine which achieves an efficient power production with the least possible temperature differences between the low temperature area and the high temperature area.

Advantages in Comparison with Other Machines for the Conversion of Mechanical Work to Electric Energy and Machines for the Conversion of Electric Energy to Mechanical Work:

The possibility of performing any kinematic cycle suggested by the Theory of Electricity, referencing either to single-phase or multi-phase electric current, so that the exerted forces, either electric or magnetic, develop either acceleration or deceleration on the separate rotors by an optimal design of motion, while the drive shaft, which in fact is either the input shaft or the output shaft, rotates with uniform motion.

The possibility of operation with only a part of the phases of a multi-phase electric current, since it is possible to design the machine so that the drive shaft rotates with uniform motion even when the separate rotors rotate with possibly asymmetrically variable motion, i.e. so that a mechanical rectification and/or a mechanical smoothing of an asymmetric electric current is achieved.

The possibility of constitution of a machine, either of volume variation in general, or of chemical volume variation in particular, with an electrically assisted improvement of the motion per se as well as of the dynamic balancing during its operation, either in general or specifically within certain periods.

The possibility of constitution of a very compact hybrid machine, whose parts cooperate and interact in the most direct way, even though they manage different energy forms.

Advantages in Comparison with the Transmission Mechanisms of all Other Machines:

The achievement of an exceptional simplicity in operation, with any precision specified, and with any progressiveness required during the acceleration and deceleration of any moving parts, and thereby the possibility of optimally designing the machine and satisfying any motion requirements, from the roughest up to the finest, without any practical limitations.

The possibility, during the operation of the machine, of controlling and adjusting many parameters related to the travels and/or the timing of the mechanism, by adjusting the angular position of the base of the reaction sun with respect to the frame of the mechanism, said adjustment taking place either only once, or at specific points within the functional cycle, of a specific duration, or on a continuous basis, either absolutely independently or in synchronization with the other motions, either finite or perpetual, modifying the functional cycle per se to a great extent.

The achievement of an absolutely constant engagement of all toothings, standard and special, with a degree of overlap exactly the same as the degree of overlap of the toothing between teeth, and with the possibility of further improving this degree of overlap, in order to achieve an even smoother and more quiet operation, by applying the currently used helical toothing, and in any case without any mechanism of immobilization or temporary connection.

The possibility, during the design phase, of controlling and adjusting either the variation of the transmission ratio, if this is allowable, or the rest of the design parameters of the toothing per se, for the purpose of optimizing the value of a particularly critical quantity, the pressure angle, within limits also found in standard toothings, thus achieving the optimal efficiency of the toothing and thereby the optimal total efficiency of the machine.

The achievement of considerable economy in moving parts, especially in those of complex construction, like the “odonto-knodaces” (cam gears), with everything that follows therefrom, due to the distributive structure and operation of the combination of planetary systems.

Advantages of the Heterocentric Interactive Distributive Oscillating Transmission Mechanism in Comparison with the Concentric Distributive Oscillating Transmission Mechanism:

The achievement of an unrivalled topological simplicity and therefore of an unrivalled ease of construction, assembly, operation and maintenance of the mechanism.

The achievement of an unrivalled robustness of all links of the kinematic train and, more specifically, of a most robust support of each toothing directly on its respective shaft, while all moving parts are actually and solely supported at both ends and of a most adequate mechanical strength.

The possibility of locating the socket configuration of the planetary shaft at the side opposite to the side of the main body of the piston, with respect to the central axis, so that said socket configuration and the corresponding planetary shaft act as a counterweight to the main body of the piston, without there being need for the presence of any other element for the static and dynamic balancing of the mechanism.

The achievement of significant compactness, mainly because of a most rational use of space and especially of the empty space on the inner side of the toroidal shell, close to and surrounding the central axis.

The achievement of almost the least possible weight for a given load-bearing capacity.

The achievement of as slow a rotation of the drive shaft as is required, when said shaft is actually the output shaft, i.e. in the case of any driving machine, so that the need for further reduction of the angular velocity in order to increase the produced torque is significantly reduced.

The achievement of as fast a rotation of the separate moving parts of a machine as is required, when the drive shaft of said machine is actually the input shaft and rotates slowly, so that the need for increasing the angular velocity is significantly reduced, as, for example, in the case of the combination of a Stirling engine, possibly built according to the respective application of the current proposal, the output shaft of said Stirling engine rotating slowly, with an electric generator, for which the Theory of Electricity requires a higher rotational speed of its moving parts, said electric generator being built according to the respective application of the current proposal, as well.

Advantages of the Coplanar Heterocentric Interactive Distributive Oscillating Transmission Mechanism in Comparison with the Concentric Distributive Oscillating Transmission Mechanism:

The achievement of the smoothest rotation possible, since no form of discontinuity is present and the “odonto-knodaces” (cam gears), the number of which is the least possible, are planar and have features almost identical to the ones of standard gears, while through the use of the currently known helical toothing, any differences between the performance of a pair of such “odonto-knodaces” (cam gears) and a pair of standard gears having a transmission ratio equal to the mean value of the variable transmission ratio of said pair of “odonto-knodaces” (cam gears), are almost completely eliminated.

The achievement of the smoothest possible application of forces and torques, since, on the one hand the action forces of all the elements are exerted within exclusively one plane and, on the other hand, the reaction forces of all the elements are also exerted within exclusively one plane.

The achievement of an unrivalled compactness, due to the deployment of all the toothings within exclusively one plane.

The achievement of the least possible weight for a given load-bearing capacity.

1. Heterocentric Interactive Distributive Oscillating Transmission mechanism, interconnecting kinematically a number of elements (1, 2, 3), which rotate coaxially around a common central axis, said mechanism being characterized by the fact that:
it performs simultaneously, continuously and perpetually a given kinematic cycle in turn at all elements, when the ratio of the angular travel of any one element during the kinematic cycle to the whole periphery is a rational number,
the frame of the mechanism (4r, 4a) is either moving, preferably with constant velocity, or, more preferably, stationary with respect to a conventionally stationary frame in space,
it has at least one reaction sun (6), whose shaft has its axis coinciding with the central axis and is fixed:
either on the frame of the mechanism,
or on a base (9) which is able to rotate around the central axis, with respect to the frame of the mechanism, and can be used to achieve, on demand, the adjustment of the travels and/or the timing of the mechanism during its operation, by imparting rotation to said base, either absolutely independently or in synchronization with the other motions, either finite or perpetual,
it has at least one action sun (7), for power input or output, whose shaft (5) is a power distributor or collector, respectively, and has its axis coinciding with the central axis, the axial position of said action sun being different from the one of the reaction sun,
the aforementioned kinematic cycle has been divided into periods so that at each period the action sun performs the same angular travel, while the number of these periods is equal to the number of the elements, so that, at any given moment, each period is performed exclusively on one element and on each element is performed exclusively one period, and afterwards the same period is performed on the next element and on the same element is performed the next period, so that on each element are performed sequentially all periods and each period is performed sequentially on all elements,
each element is supported, with continuous rotational freedom around the central axis, via an arm (31) having two branches deployed perpendicularly to the central axis and ending to two hubs (32), one on the side of the reaction sun, said hub being supported either on the shaft of the reaction sun or on another shaft, and the other on the side of the action sun, said hub being supported either on the shaft of the action sun or on another shaft, both hubs being coaxial with the central axis and at an adequate axial distance from each other to receive any non-axial torque, said axial distance being preferably common for all the elements,
each element has a planetary shaft (11 or 12 or 13) which rotates freely around a planetary axis lying in parallel and eccentrically with respect to the central axis, said planetary shaft having one reaction planet (11r or 12r or 13r, respectively) cooperating with the reaction sun, and one action planet (11a or 12a or 13a, respectively) cooperating with the action sun, both planets fixed on said planetary shaft, preferably close to its middle, so that said planetary shaft cooperates simultaneously with the reaction sun and the action sun,
each element has a socket configuration (34) on the body of its arm branches, which supports the corresponding planetary shaft with continuous rotational freedom around its planetary axis, said socket configuration receiving any non-axial torque and being preferably located at the side opposite to the side of the main body of said element, with respect to the central axis, so that said socket configuration and its corresponding planetary shaft act as a counterweight to the main body of the element,
the arm of each element has, where necessary, openings (35) on its two branches which are perpendicular to the central axis, such that the unobstructed rotation of this element with respect to the planetary shafts of other elements is allowed, in a specific angular travel sufficient for the function of the transmission,
the reaction sun and the reaction planet of any one element have conjugate toothing profiles, of variable or constant transmission ratio, so that said element rotates with variable velocity and according to the aforementioned kinematic cycle, the mean value of said variable or constant transmission ratio being such that, when a complete kinematic cycle is performed, the ratio of the angular travel of the reaction planet around its planetary axis to the periphery is a rational number, preferably a ratio of small integers, and more preferably a small integer, so that, when a group of complete kinematic cycles is performed, an integral number of complete revolutions of the element around the central axis with respect to the reaction sun is executed and a, different in general, integral number of complete revolutions of the reaction planet around its planetary axis is executed, and the reaction planet returns to its initial engagement position with respect to the reaction sun and the same group of complete kinematic cycles is repeated identically ad infinitum,
the action sun and the action planet of any one element have conjugate toothing profiles, of variable or constant transmission ratio, so that the action sun performs a uniform rotation around the central axis and said element rotates with variable velocity according to the aforementioned kinematic cycle, the mean value of said variable or constant transmission ratio being such that, when a complete kinematic cycle is performed, the ratio of the angular travel of the action sun around the central axis to the periphery is a rational number, preferably a ratio of small integers, and more preferably the inverse of a small integer, so that, when a group of complete kinematic cycles is performed, an integral number of complete revolutions of the action sun around the central axis with respect to said element is executed and a, different in general, integral number of complete revolutions of the action planet around its planetary axis is executed, and the action sun and the action planet return to their initial engagement position and the same group of complete kinematic cycles is repeated identically ad infinitum,
any pair, consisting of one sun and one planet, with the aforementioned conjugate toothing profiles, on condition that the number of complete revolutions of at least one member that is required for the return of this member to its initial engagement position is greater than one, and that the section of said toothing profile of this member corresponding to a complete revolution is not identical with the section of the toothing profile of the previous complete revolution, is deployed so that, as the angular position of the formation point of the profile changes, its axial position changes as well, either gradually in a stepwise mode or continuously in the form of a helix, the produced axial displacement for the respective angular displacement in both cases being such as to allow the unobstructed predefined one-to-one cooperation between the members of each pair, and said members are consequently completed after an integral number of turns, generally different for each member,
any type of toothing described above, stepwise or helical, has additionally at least half a tooth before its starting point, the profile of said tooth corresponding to the one right before the ending point, and at least half a tooth after its ending point, the profile of said tooth corresponding to the one right after the starting point, so that the engagement of the members of the pairs of each element is absolutely constant and the degree of overlap of the toothings, during the transition of their engagement from the ending point to the starting point anew, is the same as the degree of overlap between single teeth, said additions being in accordance with the aforementioned stepwise or helical deployment.

2. Heterocentric Interactive Distributive Oscillating Transmission mechanism, according to claim 1, further characterized by the fact that:
the direction of propagation of the performed kinematic cycle is alternatively and exclusively such that the period which is performed on any element, is afterwards performed on:
either the leading element,
or the following element,
the direction of rotation of the elements and their resulting order being viewed within a complete kinematic cycle, in both cases,
the direction of rotation of the action sun with respect to the elements is alternatively and exclusively:
either the same as
or opposite to
the direction of rotation of the elements, the latter being viewed within a complete kinematic cycle, in both cases,
the toothings being used, regarding their topology, are alternatively and exclusively:
either all external toothings,
or a combination of external toothings for all the planets and internal toothings for all the suns,
the toothings being used, regarding their geometry, are:
either straight toothings,
or helical toothings,
or a combination of these two types.

3. Heterocentric Interactive Distributive Oscillating Transmission mechanism, according to claim 1 or claim 2, further characterized by the fact that:
the reaction planets (11 r, 12r, 13r) are identical for all the elements and have only different angular positions and possibly different axial positions,
the reaction planet of each element, alternatively and exclusively, cooperates with:
either a unique reaction sun (6), common for all the reaction planets,
or a separate reaction sun for each element, said reaction sun having a specific angular position and a specific axial position so as to have an one-to-one cooperation with the respective reaction planet, and preferably being identical with all the other reaction suns regarding the rest of its features,
the action planets (1 1 a, 12a, 13a) are identical for all the elements and have only different angular positions and possibly different axial positions,
the action planet of each element, alternatively and exclusively, cooperates with:
either a unique action sun (7), common for all the action planets,
or a separate action sun for each element, said action sun having a specific angular position and a specific axial position so as to have an one-to-one cooperation with the respective action planet, and preferably being identical with all the other action suns regarding the rest of its features.

4. Coplanar Heterocentric Interactive Distributive Oscillating Transmission mechanism, according to claim 2 or claim 3, further characterized by the fact that:
the direction of propagation of the given kinematic cycle is such that the period performed by any element is afterwards performed by the following element,
the direction of rotation of the action sun is opposite to the one of the elements,
all the toothings being used are external and either straight or helical,
the reaction sun and the reaction planet have conjugate toothing profiles of variable transmission ratio, the mean value of said variable transmission ratio being a ratio of small integers, preferably equal to one, and said reaction sun is preferably fixed on a base to rotate around the central axis with respect to the frame of the mechanism, so that, by imparting an either finite or perpetual rotation to said base, either absolutely independently or in synchronization with the other motions, the travels and/or the timing of the mechanism are adjusted, and said reaction sun is planar and common for all the reaction planets, said reaction planets all being planar as well,
the action sun and the action planet have conjugate toothing profiles of constant transmission ratio, and said action sun is planar and common for all the action planets, said action planets all being planar as well.

5. Machine of volume variation or else Toroidal Hermetic Rotary Engine, via which the periods of a functional cycle are performed continuously and perpetually and result in the conversion of energy from one form to another through volume variation, said machine consisting of a hollow shell (4r, 4a), the internal surface (14) of said shell being toroidal, i.e. a surface of revolution having any planar, closed and smooth curve as its generating line, and of a plurality of pistons (1, 2, 3), said pistons being parts of a toroid of such dimensions as to cooperate with said shell, and moving with respect both to the shell and to each other, the variable volume being defined by the internal surface of the shell and the faces (28, 29) of two consecutive pistons, said machine being further characterized by the fact that:
the kinematic interconnection of said pistons is achieved, alternatively and exclusively, via:
either the Heterocentric Interactive Distributive Oscillating Transmission mechanism, according to claim 1 or claim 2 or claim 3,
or the Coplanar Heterocentric Interactive Distributive Oscillating Transmission mechanism, according to claim 4,
said interconnecting mechanism being hereafter referred to, in both cases, simply as “mechanism”,
the shell of the engine is either rotating around the central axis of the mechanism, preferably with constant velocity, or, more preferably, stationary, with respect to the frame of the mechanism,
the continuity of said toroidal internal surface is interrupted by a peripheral slot (15), said slot extending on the whole periphery of the shell, at any angular position on the generating line of the toroid, and preferably internally, i.e. on the side of the central axis of the engine,
a plurality of units are arranged on the aforementioned shell, equally spaced along the shell periphery, each of said units consisting of openings or areas of intentionally reduced thermal insulation, so as to allow the transfer either of mass or of energy or of a combination of both, between the interior and the exterior of the shell, the functional cycle starting at the beginning of each unit and being completed at its end, each of said units being called a “station”,
after the completion of a functional cycle at the end of a station an additional kinematic process is interposed, which may either constitute on its own one or more periods in a thus extended functional cycle or be incorporated in the already existing periods, said process comprising the transition of two successive and cooperating pistons to the next station, the pistons resting and being relieved from mechanical, thermal and chemical stresses during said transition and performing thereafter anew and identically the same functional cycle, said process being called “re-stationing”,
the ratio of the angular travel performed by any piston within an extended functional cycle to the periphery, is a ratio of small integers, resulting in a reasonable number of stations to be constructed, said ratio being preferably equal to the inverse of a small integer, the number of stations being then equal to this integer,
the number of the pistons, and consequently the number of the elements of the mechanism, since the piston is actually the element of the mechanism, is equal to the number of the periods of the extended functional cycle,
the pistons are structurally almost identical and each piston consists of:
a structural frame that is fixed directly on the arm (31) of the respective element of the mechanism, said frame being constructed in such a manner that the necessary strength for receiving any force and torque, with the least possible moment of inertia and centrifugal force, is achieved,
and the following structural parts which are fixed or laid on said frame:
two limiting faces, the front face (28) and the rear face (29), both taking part in the operation of the machine and being surfaces generated by the section of toroidal parts, with such radial and angular dimensions and at such an angular distance from each other, that the volumes required during the extended functional cycle are formed between the rear face of one piston and the front face of its following piston, said faces having such shape as to favour the most efficient torque receipt or transmission with respect to the machine central axis, the simplest such shape being the plane and preferably the meridian plane,
at least one groove per each face is deployed on the body of the piston close to the faces, preferably in the meridian plane, a sealing ring being held inside said at least one groove, so that a most hermetic sealing of the piston with the cooperating internal surface of the shell is achieved in the meridian direction,
one peripheral rib (24), i.e. a peripheral extension tangential to the body of the piston, said extension being practically part of the ring of the toroidal shell which was cut out in order to form the peripheral slot, said peripheral rib having the axial thickness of the cut out ring and being deployed starting from an angular position between the piston faces, which lies at an adequate, with regard to mechanical strength, angular distance from the, either rear or front, piston face and extending outside the piston body boundaries towards the, either following or leading, respectively, piston, said peripheral rib having an angular width such as, on the one hand, to cover adequately the opening of the peripheral slot when the, either following or leading, respectively, piston is at its maximum distance from said piston and, on the other hand, to allow for the unobstructed relative motion of the two pistons up to the point where their cooperating faces contact each other, while said peripheral rib is supported directly by the previously described arm (31) on the whole of its angular width,
two groups of peripheral sealing elements, both groups being inside grooves, said grooves being deployed both on the aforementioned peripheral rib and on the opposite to said peripheral rib surfaces of the peripheral slot of the shell, one of said groups being held inside the groove on said peripheral rib, and thus following the motion of the piston (25), the other being held inside the groove on the opposite to said peripheral rib surface of the peripheral slot of the shell, and thus covering continuously the whole periphery and following the motion of the shell (20), each of said groups consisting of at least two elements situated on both sides of the peripheral rib with regard to the axial direction, said sealing elements either having a special meander cross-section or being spring steel elements or elements of special chemical composition or a combination of these, thus ensuring the hermetic sealing of the peripheral ribs of the pistons with the cooperating surfaces of the peripheral slot of the shell, in the peripheral direction,
at least two sealing surfaces (26, 27), at angular positions on the generating line of the toroid, where their presence is necessary, either for sealing the intake port (26) and the exhaust port (27), or for sealing the inlet port and the outlet port, or for the thermal insulation of the “low temperature” area “port” and the “high temperature” area “port”,
one connecting rod (23), whose two ends are fixed on the two toroidal parts of the piston closed to the two active faces, no other connection between said rod and the structural frame of the piston being present, the thermal expansion coefficient being less than or equal to the thermal expansion coefficients of the other structural parts that constitute the structural frame of the piston, so that the deviation from the toroidal shape caused by the temperature changes is dimensionally compensated for, said toroidal shape being maintained, at least in the regions close to the faces, and consequently the required excellent cooperation with the respective internal surface of the shell is pursued,
the pistons, finally, are functionally absolutely identical, are arranged within the shell and rotate having differentiated angular travels at each period of the extended functional cycle, so that said cycle is performed in the most efficient possible manner, while, at all times, each period is performed consecutively within the space defined by the faces of two successive pistons, and due to the fact that the two active faces of each piston take part in two successive pairs of cooperating pistons, it follows that the rest of the cooperating piston pairs perform consecutively the same motions with a relative phase difference, and therefore each period being performed at one station, is afterwards performed at the next station, and so on ad infinitum.

6. Machine of chemical volume variation or else, variable volume or piston stroke internal combustion engine, performing any thermodynamic cycle, for example either Otto cycle or Diesel cycle or Atkinson cycle, according to claim 5, being further characterized by the following:
each station consists of:
at least one fuel intake port (16),
at least one device (30) for causing ignition of the air-fuel mixture, either via spark or via injection of pure fuel or air-fuel mixture at a self-ignition pressure or via any other method, unless said one or more ignition devices (30) are located on one or on both faces of each piston,
at least one exhaust gas port (17), at an angular position on the generating line of the toroid, preferably other than the angular position of the fuel intake port,
any other openings or devices, e.g. preheating, cooling and cleaning, aiming at improving the performance of the thermodynamic cycle,
an additional motion, preferably, has been incorporated into the re-stationing process, that is the parting of the cooperating pistons at an opening (19) of corresponding angular dimensions on the shell, said opening lying between the exhaust port of one station and the intake port either of the next station or of the same station in case there is only one station.

7. Machine of chemical volume variation, or else variable volume or piston stroke internal combustion engine, or else Toroidal Hermetic Rotary Extended Expansion Engine, according to claim 6, further characterized by the following:
the shell of the engine is stationary with respect to the frame of the mechanism,
the extended functional cycle of the engine consists of three periods:
a) “intake and compression”, said period being directly defined so that the intake phase of pure air or pure air-fuel mixture and the compression phase of said air or air-fuel mixture up to a predetermined compression ratio are performed most effectively,
b) “expansion”, said period being directly defined so that possibly the injection phase and certainly the expansion phase, i.e. the combustion of the air-fuel mixture of the intake phase and possibly of the injection phase at the start of said expansion period, is performed most effectively, with a travel which is an unlimited multiple of the travel of the intake phase,
c) “exhaust and re-stationing”, said period being indirectly defined by the design of the two aforementioned periods, according to the properties of the “diadocho-kinesis” operation, so that the exhaust phase of the gases and the re-stationing process are performed,
it has, as a result, three pistons,
it has only one station, with the angular travel of the re-stationing process defined respectively.

8. Machine of mechanical volume variation using either a liquid working medium or a gas working medium, which either produces mechanical work being a hydraulic motor or a pneumatic motor, respectively, or consumes mechanical work being a hydraulic pump or a pneumatic pump, respectively, said machine being defined according to claim 5, and being further characterized by the following:
the shell of the machine is either stationary or moving with respect to the frame of the mechanism, satisfying different operational requirements,
each station consists of:
at least one working medium inlet port, and
at least one working medium outlet port, at an angular position on the generating line of the toroid, preferably other than the angular position of the inlet port,
the faces of the pistons preferably have a perfect fit, so that, during the “influx” period, only working medium of “influx” energy level is admitted and, during the “efflux” period, a complete expulsion of working medium of “efflux” energy level takes place.

9. Machine of thermal volume variation which either uses thermal energy derived from external combustion or other kinds of heat, such as solar energy and geothermal energy, as its input and produces mechanical work at its output, hence being called a Stirling engine, or vice versa, consumes mechanical work at its inlet and performs a refrigeration cycle, hence being called a refrigeration machine or heat pump, said machine being defined according to claim 5, and being further characterized by the following:
the shell of the machine is either stationary or moving with respect to the frame of the mechanism, satisfying different operational requirements, and has an effective thermal insulation throughout its whole body thickness,
each station consists of:
at least one “port” to a “low temperature” area,
at least one “port” to a “high temperature” area, at an angular position on the generating line of the toroid, preferably other than the angular position of the “port” to the “low temperature” area, said “ports” having intentionally reduced thermal insulation,
the faces of the pistons have either a perfect fit or an almost perfect fit and an overall minimum angular distance from each other, when they are at their closest proximity, so that the overall minimum volume, required when the working medium is in a condensed liquid state during the “compression” period, is formed, while each piston has an effective thermal insulation throughout its whole body thickness.

10. Electric machine, either generator or motor, with a multiple-part rotor, which either converts mechanical work to electric energy or electric energy to mechanical work, respectively, said machine having at least one stator, i.e. either a permanent magnet or an electromagnet, and being further characterized by the following:
it has a plurality of independently moving parts, each of said parts being a rotor, i.e. either a permanent magnet or an electromagnet, and rotating around a central axis, common for all the moving parts, with variable velocity in an optimal manner and so that the aforementioned energy conversion, related either to single-phase or to multi-phase current, is achieved with the best possible efficiency,
the kinematic interconnection of said moving parts is achieved, alternatively and exclusively, via:
either the Heterocentric Interactive Distributive Oscillating Transmission mechanism, according to claim 1 or claim 2 or claim 3,
or the Coplanar Heterocentric Interactive Distributive Oscillating Transmission mechanism, according to claim 4,
or the machine of volume variation, in general, according to claim 5,
or the machine of mechanical volume variation, in particular, according to claim 8,
or the machine of thermal volume variation, in particular, according to claim 9,
or the machine of chemical volume variation, in particular, according to claim 6 or claim 7, so that, in the last type of kinematic interconnection:
either an electrically assisted improvement of the motion per se as well as of the dynamic balancing during the operation of said machine is achieved, either in general or specifically within certain periods,
or a compact hybrid engine is built, whose parts cooperate and interact in the most direct way, managing different energy forms,
the stator of said machine is either rotating around the central axis of the interconnecting mechanism, preferably with constant velocity, or, more preferably, stationary with respect to the frame of said mechanism, in all the aforementioned cases.
